(19) United States
(12) Patent Application Publication
(10) Pub. No.: US 2026/0249228 A1
(43) Pub. Date: Aug. 27, 2026

(54) ADSORBENT AND SYSTEMS FOR DIRECT AIR CAPTURE

(71) Applicant: INGEVITY SOUTH CAROLINA, LLC, North Charleston, SC (US)

(72) Inventors: Mohammadreza Fayaz, North Charleston, SC (US); Cameron Thomson, North Charleston, SC (US)

(21) Appl. No.: 19/548,664

(22) Filed: Feb. 24, 2026

Related U.S. Application Data
(60) Provisional application No. 63/762,459, filed on Feb. 24, 2025.

(51) Int. Cl. B01D 53/04; B01J 20/20

(52) U.S. Cl. CPC B01D 53/0407; B01J 20/20; B01D 2253/102; B01D 2253/25; B01D 2253/306; B01D 2253/311; B01D 2253/3425; B01D 2257/504

(57) ABSTRACT

The present description provides adsorbent compositions and materials, and systems comprising the same for direct air capture (DAC) of VOCs and/or CO₂ from air, or a fluid or vaporous stream point source. The described materials provide unexpected production advantages as compared to currently available materials.

### CROSS-REFERENCE TO RELATED APPLICATIONS

This application claims the benefit under 35 U.S.C. 119(e) of earlier filed U.S. Provisional Patent Application Ser. No. 63/762,459 titled: Adsorbent and Systems for Direct Air Capture, filed: 24 Feb. 2025, which is incorporated herein by reference in its entirety for all purposes.

### BACKGROUND

1. Field. The present invention relates to adsorbent materials for the treatment of an fluid/gas stream (e.g., an exhaust gas), or direct air capture (DAC) of carbon dioxide (CO₂) and/or one or more volatile organic compounds (VOCs) from air or a fluid stream comprising the same. The present invention also relates to systems and methods comprising the same.

2. Background Information. Gas emissions from power plants and other industrial activities include pollutants in air, exhaust streams and flue gases. There is often a need to process such exhaust streams, flue gases or air before discharge into the environment. One important flue gas component that needs to be separated is CO₂, which typically has a high concentration depending on the industry. This is because it is one of the major greenhouse gases that significantly contributes to global warming. Therefore, industrial systems capable of removing or sequestering CO₂ and/or VOCs are of high importance and interest.

CO₂ capture is primarily done from two sources: 1) point sources such as flue gas from power plants; and 2) CO₂ in the air (direct air capture or DAC). Point source flue gas has typically high CO₂ concentration; however, CO₂ in air has a relatively low concentration of only about 400 ppm. Therefore, DAC is trickier to complete because it requires high flow rate to have effective separation at that low concentration. Adsorbent systems for DAC, which is also known as “contactors,” should have very low pressure drop at high flow rates. As such, a structured adsorbent having internal air flow passages, e.g., a honeycomb structure, is a good candidate structure. It should be noted that having low pressure drop for a point source is also important but not as important as in DAC.

Unlike point-source capture, DAC systems are not tied to specific emission sources (e.g., power plants) and therefore can be sited in many locations. This is usually framed as geographic flexibility, decoupling from emission sources, or ability to co-locate with storage or utilization sites. Conventional large-scale CO₂ removal systems face a number of practical challenges, for example, the requirement for adsorbent materials with high CO₂ capacity and affinity, suitable adsorption kinetics, optimal hydrothermal stability, and pressure drop. Due to the large volumetric flow rates required for direct air capture, the contactor and adsorbent materials should be configured to provide low pressure drop, thereby minimizing energy requirements and overall operating costs.

There is an ongoing need in the art for adsorbent solutions to capture CO₂ and VOCs from point sources as well as in direct air capture (DAC) for balancing tradeoffs in terms of cost, capacity, performance, complexity, flow restriction, and system flexibility. As such, it is desirable to have a higher performing adsorbent that would allow cost effective, efficient and less complicated system design and operation for the removal of CO₂ and/or other contaminants from air, air streams and flue gases.

### SUMMARY

Presently described are adsorbent materials, for example, a structured adsorbent monolith, e.g., an activated carbon honeycomb (“ACH”), impregnated or functionalized with a CO₂ sequestering agent, e.g., potassium carbonate or an amine. As described herein, amine functionalized structured adsorbent monoliths have high CO₂ capture capacity, are robust, and hydrothermally stable. The described adsorbent monoliths provide high CO₂ adsorption and low flow restriction, and therefore, are advantageous for inclusion in direct air capture (DAC) systems for reversible adsorption of CO₂ as well as for deployment in exhaust streams, and industrial flue gas streams.

Thus, in an aspect, the disclosure provides a structured adsorbent monolith comprising a ceramic matrix material and an adsorbent material, wherein the monolith includes a plurality of hollow passages therethrough, and wherein the adsorbent is functionalized or impregnated with a CO₂ sequestering agent, e.g., potassium carbonate or an amine. In any aspects or embodiments described herein, the structured adsorptive monolith is extruded or coated with an activated adsorbent material, CO₂ sequestering agent or both. In any aspects or embodiments described herein, the structured adsorptive monolith comprises an activated adsorbent, e.g., an activated carbon adsorbent and a ceramic matrix. In any aspects or embodiments described herein, the ceramic matrix comprises at least one of a zeolite, clay, porous polymer, porous alumina, porous silica, molecular sieve, kaolin, titania, ceria, or a combination thereof.

In any aspects or embodiments described herein, the structured adsorbent monolith comprises an activated adsorbent, wherein the activated adsorbent comprises activated carbon, e.g., activated carbon powder or granules. In any aspects or embodiments described herein, the activated carbon is derived from at least one of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, a synthetic polymer, natural polymer, lignocellulosic material, or a combination thereof. In any aspects or embodiments described herein, the activated carbon is characterized by a nitrogen B.E.T. surface area from about 600 to about 3000, or from about 800 to about 2500, or about 1000 to about 2000 square meters per gram.

In any aspects or embodiments described herein, the structured adsorbent monolith comprises from about 10 wt % to about 95 wt %, from about 20 wt % to about 80 wt %, or from about 20 wt % to about 70 wt % activated carbon. In any aspects or embodiments described herein, the structured adsorbent monolith is a honeycomb (e.g., geometrical prism, such as, e.g., cylindrical, square or rectangular, oval, etc.) having a cell density of from about 100 to about 1000 cpsi (e.g., from about 200 to about 900 or from about 200 to 800 or from about 200 to about 600). In any aspects or embodiments described herein, honeycomb has a cell wall thickness of from about 0.1 mm to about 0.5 mm.

In any aspects or embodiments described herein, the structured adsorptive monolith comprises at least one of an organic binder, inorganic binder a mineral flux or a combination thereof. In any aspects or embodiments described herein, the inorganic binder comprises a clay binder, e.g., calcined kaolin. In any aspects or embodiments described herein, the organic binder comprises a cellulose, e.g., methylcellulose, a cellulose derivative, or a combination thereof. In any aspects or embodiments described herein, the mineral flux comprises feldspathic material, nepheline syenite or a combination of both.

In any aspects or embodiments described herein, the clay binder comprises zeolite clay, bentonite clay, montmorillonite clay, illite clay, French green clay, pascalite clay, redmond clay, terramin clay, living clay, Fuller's Earth clay, ormalite clay, vitallite clay, rectorite clay, cordierite, ball clay, kaolin, e.g., calcined kaolin, hydrous kaolin, a calcined clay binder material, or a combination thereof. In any aspects or embodiments described herein, the calcined binder material comprises calcined kyanite, mullite, cordierite, clay grog, silica, alumina, and other calcined or non-plastic refractory ceramic materials, or a combination thereof. In any aspects or embodiments described herein, the ceramic matrix comprises sodium silicate.

In any aspects or embodiments described herein, the organic binder comprises at least one of carboxymethyl cellulose, methyl cellulose, ethyl cellulose, ethyl methyl cellulose, hydroxyethyl cellulose, hydroxypropyl cellulose, hydroxyethyl methyl cellulose, hydroxypropyl methyl cellulose, methyl hydroxyethyl cellulose, ethyl hydroxyethyl cellulose, crystalline salts of aromatic sulfonates, polyfurfuryl alcohols, furfural, polyesters, polyepoxides, polyurethane polymers, polyvinyl alcohol or a combination thereof.

In any aspects or embodiments described herein, the amine used to functionalize or impregnate the structured adsorbent monolith described herein, comprises a polyamine. In any aspects or embodiments described herein the polyamine comprises at least one of diamine (putrescine, cadaverine); triamine (spermidine), tetraamine (spermine), macrocyclic polyamines (1, 4, 7-triazacyclononane), tris(2-aminoethyl)amine, cyclean, 1,1,1-tris(aminomethyl)ethane, polyethylenimine (PEI), hexamethylenetetramine, ethyleneamines (ethylenediamine; EDTA, TMEDA), dimethylenetriamine, trimethylenetetramine, tetramethylenepentamine, pentamethylenehexamine, diethylenetriamine (DETA), triethylenetetramine (TETA), tetraethylenepentamine (TEPA), pentaethylenehexamine (PEHA), polyethylenepolyamine (PEPA), aminoethylethanolamine (AEEA), dipropylenetriamine, tripropylenetetramine, tetrapropylenepentamine, pentapropylenehexamine, dibutylenetriamine, tributylenetetramine, tetrabutylenepentamine, pentabutylenehexamine, aminoethylpiperazine, dipropylenetriamine, heavy polyamine X (HPA X), tallow amines, isomers thereof, salts thereof, complexes thereof, adducts thereof, or any mixture thereof. In some examples, the polyamine can be or include a mixture of linear, branched, and/or cyclic ethyleneamines and/or other alkyleneamines, polyethylene polyamines, pentaethylenehexamine mixtures, tetraethylenepentamine mixtures, triethylenetetramine mixtures, isomers thereof, salts thereof, or a combination thereof.

In any aspects or embodiments described herein, the polyamine comprises at least one of polyethylenimine (PEI), tetraethylenepentamine (TEPA), pentaethylenehexamine (PEHA), polyethylenepolyamine (PEPA), aminoethylethanolamine (AEEA), or a combination thereof.

In an additional aspect, the description provides a method of making a structured adsorbent monolith as described herein comprising, providing a mixture of an activated adsorbent material and a ceramic matrix material, extruding the material to form an structured adsorbent monolith and optionally calcining the extruded structured adsorbent monolith, and treating the structured adsorbent monolith with CO₂ sequestering agent, e.g., potassium carbonate or an amine, e.g., where the CO₂ sequestering agent is an amine or a polyamine, forming an amine-functionalized structured adsorbent monolith. In any aspect or embodiment described herein, the structured adsorbent monolith is treated with an amine by dipping into a solution comprising an amine, e.g., a polyamine. In an additional aspect, the polyamine is included in the mixture with the activated adsorbent material, e.g., activated carbon powder, and a ceramic matrix material prior to extrusion. In still additional embodiments, the polyamine is applied by spray coating onto the structured adsorbent monolith.

In an additional aspect, the description provides a VOC or CO₂ capture system, e.g., direct air capture (DAC) system, comprising an air stream conduit for providing air comprising a VOC or CO₂ in communication with a chamber or housing comprising a structured adsorbent as described herein (e.g., a contactor), which is in communication with a vent conduit that is open to the atmosphere. The contactor can be comprised within an industrial air stream treatment system or included in the exhaust system of a combustion engine vehicle.

In an additional aspect, the description provides methods for reducing carbon dioxide emissions from an air stream point source or in a direct air capture (DAC) system, the method comprising contacting air or an air stream (e.g., an exhaust stream or flue gas) comprising a VOC or CO₂ with a system comprising a structured adsorbent monolith, e.g., a functionalized activated carbon honeycomb (ACH) as described herein. In certain embodiments, the method includes a step of regeneration of the structured adsorbent monolith by treating or exposing the adsorbent monolith with at least one of hot air, steam, electromagnetic radiation (e.g., microwave energy, or radio frequency), resistive heating or a combination thereof, thereby desorbing bound VOC or CO₂ from the structured adsorbent monolith.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1. Shows a perspective view of an amine-functionalized monolith made in accordance with an embodiment of this invention.

FIG. 2. Shows a partial side elevation view of the monolith of FIG. 1 with a portion of the skin removed to illustrate the flow of fluid through the amine-functionalized honeycomb passages of the monolith.

FIG. 3. Shows pore volume as a function of amine loading for an activated carbon honeycomb monolith (ACH) comprising 30 wt % activated carbon (“30 wt % ACH”) functionalized or impregnated with TEPA.

FIG. 4. Shows pore volume as a function of amine loading for an activated carbon honeycomb monolith (ACH) comprising 30 wt % activated carbon (“30 wt % ACH”) functionalized or impregnated with PEI.

FIG. 5. Shows pore volume as a function of amine loading for an activated carbon honeycomb monolith (ACH) comprising 50 wt % activated carbon (“50 wt % ACH”) functionalized or impregnated with TEPA.

FIG. 6. Shows pore volume as a function of amine loading for an activated carbon honeycomb monolith (ACH) comprising 50 wt % activated carbon (“50 wt % ACH”) functionalized or impregnated with PEI.

FIG. 7. Shows the effect of amine loading (wt %) on BET surface area (m²/g) for activated carbon honeycomb monoliths (ACH) comprising 30 wt % or 50 wt % activated carbon and functionalized or impregnated with either PEI or TEPA.

FIG. 8. Shows CO₂ uptake on untreated activated carbon powder (“RGC”), and PEI functionalized activated carbon honeycomb monoliths (ACH) having 30 wt % activated carbon (“30 wt % ACH”) under 10 vol % CO₂ with amine loading in 5%, 10%, 15%, 20% and 25% PEI solutions, at three temperatures: 25° C., 50° C., and 75° C.

FIG. 9. Shows CO₂ uptake on untreated activated carbon powder (“RGC”), and PEI functionalized activated carbon honeycomb monoliths (ACH) having 50 wt % activated carbon (“50 wt % ACH”) under 10 vol % CO₂ with amine loading in 5 wt %, 10 wt %, 15 wt %, 20 wt % and 25 wt % PEI solutions, at three temperatures: 25° C., 50° C., and 75° C.

FIG. 10. Shows CO₂ uptake on untreated activated carbon powder (“RGC”), and PEI functionalized activated carbon honeycomb monoliths (ACH) having 30 wt % or 50 wt % activated carbon with amine loading in 5 wt %, 10 wt %, 15 wt %, 20 wt % and 25 wt % PEI solutions under 400 ppm CO₂ at a temperature of 30° C.

FIG. 11. Shows the amine efficiency of CO₂ uptake for PEI functionalized activated carbon honeycomb monoliths (ACH) comprising 30 wt % activated carbon (“30 wt % ACH”) with amine loading in 5 wt %, 10 wt %, 15 wt %, 20 wt % and 25 wt % PEI solutions under 10 vol % CO₂ at three temperatures: 25° C., 50° C., and 75° C.

FIG. 12. Shows the amine efficiency of CO₂ uptake for PEI functionalized activated carbon honeycomb monoliths (ACH) comprising 50 wt % activated carbon (“50 wt % ACH”) with amine loading in 5 wt %, 10 wt %, 15 wt %, 20 wt % and 25 wt % PEI solutions under 10 vol % CO₂ at three temperatures: 25° C., 50° C., and 75° C.

FIG. 13. Shows amine efficiency of CO₂ uptake for PEI functionalized activated carbon honeycomb monoliths (ACH) having 30 wt % or 50 wt % activated carbon with amine loading in 5 wt %, 10 wt %, 15 wt %, 20 wt % and 25 wt % PEI solutions under typical direct air capture (DAC) conditions of 400 ppm CO₂ at a temperature of 30° C.

FIG. 14. Shows CO₂ uptake on untreated activated carbon powder (“RGC”), and TEPA functionalized activated carbon honeycomb monoliths (ACH) having 30 wt % activated carbon (“30 wt % ACH”) with amine loading in 5 wt %, 10 wt %, 15 wt %, 20 wt % and 25 wt % TEPA solutions under 10 vol % CO₂ at three temperatures: 25° C., 50° C., and 75° C.

FIG. 15. Shows CO₂ uptake on untreated activated carbon powder (“RGC”), and TEPA functionalized activated carbon honeycomb monoliths (ACH) having 50 wt % activated carbon (“50 wt % ACH”) with amine loading in 5 wt %, 10 wt %, 15 wt %, 20 wt % and 25 wt % TEPA solutions under 10 vol % CO₂ at three temperatures: 25° C., 50° C., and 75° C.

FIG. 16. Shows CO₂ uptake for TEPA functionalized activated carbon honeycomb monoliths (ACH) having 30 wt % or 50 wt % activated carbon with amine loading in 5 wt %, 10 wt %, 15 wt %, 20 wt % and 25 wt % TEPA solutions under typical direct air capture (DAC) conditions of 400 ppm CO₂ at a temperature of 30° C.

FIG. 17. Shows the amine efficiency of CO₂ uptake for TEPA functionalized activated carbon honeycomb monoliths (ACH) comprising 30 wt % activated carbon (“30 wt % ACH”) with amine loading in 5 wt %, 10 wt %, 15 wt %, 20 wt % and 25 wt % TEPA solutions under 10 vol % CO₂ at three temperatures: 25° C., 50° C., and 75° C.

FIG. 18. Shows the amine efficiency of CO₂ uptake for TEPA functionalized activated carbon honeycomb monoliths (ACH) comprising 50 wt % activated carbon (“50 wt % ACH”) with amine loading in 5 wt %, 10 wt %, 15 wt %, 20 wt % and 25 wt % TEPA solutions under 10 vol % CO₂ at three temperatures: 25° C., 50° C., and 75° C.

FIG. 19. Shows amine efficiency of CO₂ uptake for TEPA functionalized activated carbon honeycomb monoliths (ACH) having 30 wt % or 50 wt % activated carbon with amine loading in 5 wt %, 10 wt %, 15 wt %, 20 wt % and 25 wt % TEPA solutions under typical direct air capture (DAC) conditions of 400 ppm CO₂ at a temperature of 30° C.

FIG. 20. Shows CO₂ breakthrough curves (saturation rate) in PEI functionalized or impregnated 50 wt % ACH at two different flow rates, 10 L/min-0% relative humidity (RH), and 25 L/min-0% RH.

FIG. 21. Shows CO₂ breakthrough curves (saturation rate) in TEPA functionalized or impregnated 50 wt % ACH at two different flow rates, 10 L/min-0% relative humidity (RH), and 25 L/min-0% RH.

FIG. 22. Shows total CO2 uptake (mmol/g) for the 50 wt % ACH functionalized or impregnated with PEI or TEPA at two different flow rates, 10 L/min-0% relative humidity (RH), and 25 L/min-0% RH.

FIG. 23. Shows CO₂ breakthrough curves (saturation rate) in PEI functionalized or impregnated 50 wt % ACH at 10 L/min under different relative humidity (RH) conditions. The graph shows that increasing humidity slows the rate of CO₂ saturation.

FIG. 24. Shows CO₂ breakthrough curves (saturation rate) in TEPA functionalized or impregnated 50 wt % ACH at 10 L/min under different relative humidity (RH) conditions. The graph shows that increasing humidity has less of an effect on TEPA impregnated ACH.

FIG. 25. Shows the CO₂ uptake capacity under direct air capture (DAC) conditions of 400 ppm CO₂ at 30° C. at different relative humidities (i.e., 0%, 25%, 50%, and 75%) for an exemplary activated carbon honeycomb monolith having 50 wt % activated carbon (50 wt % ACH).

FIG. 26. Shows regenerative capacity of an activated carbon honeycomb monolith as described herein. The 50 wt % ACH sample was heated at 110° C. for 1 hour under N₂ to regenerate during the cycles. After running 12 consecutive adsorption/regeneration, the DAC capacity was only slightly reduced.

FIG. 27. Shows the CO₂ uptake (mmol/g) of an activated carbon honeycomb monolith functionalized 30 wt % ACH with either PEI or TEPA at different relative humidities. The graph shows that the capacity of TEPA functionalized ACH is less affected by humidity.

FIG. 28. Specific heat capacity (Cp) comparison of non-functionalized adsorbent materials, including 50 wt % ACH, 30 wt % ACH, G10 silica, and activated carbon powder (“RGC”).

FIG. 29. Shows pressure drop versus velocity of air flow across the face of a structured adsorbent monolith as described herein.

FIG. 30. Shows the DFT pore volume distribution for uncalcined and calcined structured adsorbent monoliths as described herein having 50 wt % activated carbon (“50 wt % ACH”).

FIG. 31. Shows the mercury pore volume distribution for uncalcined and calcined structured adsorbent monoliths as described herein having 50 wt % activated carbon (“50 wt % ACH”)

FIG. 32. Shows the DFT cumulative pore volume distribution for calcined structured adsorbent monoliths as described herein having 50 wt % activated carbon (“50 wt % ACH”) before and after 60 hour steam treatment.

FIG. 33. Shows the mercury pore volume distribution for uncalcined structured adsorbent monoliths as described herein having 50 wt % activated carbon (“50 wt % ACH”) before and after 60 hour steam treatment.

### DETAILED DESCRIPTION

The present disclosure now will be described more fully hereinafter, but not all embodiments of the disclosure are shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular structure or material to the teachings of the disclosure without departing from the essential scope thereof. The drawings accompanying the application are for illustrative purposes only. They are not intended to limit the embodiments of the present application. Additionally, the drawings are not drawn to scale. Elements common between figures may retain the same numerical designation.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

As used herein, the terms “fluid,” “gas” or “gaseous” and “vapor” or “vaporous” are used in a general sense and, unless the context indicates otherwise, are intended to be interchangeable.

As used herein, in direct air capture (DAC), a “contactor” is the engineered unit where ambient air is brought into contact with a CO₂-selective material (sorbent or solvent) so that CO₂ is captured from the air.

U.S. patent application Ser. No. 15/656,643 titled: Particulate Adsorbent Material and Methods of Making the Same, filed 21 Jul. 2017; U.S. Patent Publication US 2016/0271555A; U.S. Pat. Nos. 9,732,649; 6,472,343; US 2017/0106330; and U.S. Pat. No. 11,439,976 are hereby incorporated by reference in their entirety for all purposes.

Presently described are adsorbent materials, for example, a structured adsorbent monolith, e.g., an activated carbon honeycomb (“ACH”), impregnated or functionalized with a CO₂ sequestering agent, e.g., potassium carbonate or an amine. As described herein, amine functionalized structured adsorbent monoliths have high CO₂ capture capacity, are robust, and hydrothermally stable. The described adsorbent monoliths provide high CO₂ adsorption and low flow restriction, and therefore, are advantageous for inclusion in direct air capture (DAC) systems for reversible adsorption of CO₂ as well as for deployment in exhaust streams, and industrial flue gas streams.

The amine functionalized adsorbent monoliths surprisingly and unexpectedly have high CO₂ capture capacity and efficiency as compared to non-functionalized materials, are robust, hydrothermally stable, and have low flow resistance. Given the low CO₂ concentration in air, CO₂ capture can only be effectively conducted by forcing large flow of air passing through contactors or cartridges containing adsorbents. Therefore, effective adsorbents, such as those described herein, should have large surface exposed to air to maximize adsorption kinetics while incurring low pressure drop.

The described structured adsorbent monoliths, e.g., adsorbent honeycomb monoliths, as described herein have a channel structure and thin cell walls, which advantageously allow for minimizing pressure drop and maximizing adsorption kinetics. As such, the structured activated adsorbent monoliths as described herein are ideal for incorporation into direct air capture (DAC) systems for the reversible capture of contaminants, e.g., CO₂ or VOCs from air, exhaust streams and industrial flue gas streams. Additionally, the described structured adsorbent monoliths comprise an activated adsorbent, e.g., activated carbon, that demonstrates desirable mesoporosity and can effectively be functionalized by amine. The presence of macroporosity in the described structured adsorbent monolith structure can also improve the amine-impregnation process as described herein.

While not being bound to any particular theory, the inventors hypothesize that the high surface area of the activated carbon adsorbent materials have a positive impact on retaining the CO₂ sequestering agent, e.g., potassium carbonate or amine, in the structure (or minimizing amine leaching) over adsorption/steam regeneration cycles. Moreover, the structured adsorbent monoliths comprising activated carbon as described herein have strong hydrothermal stability providing a robust solution for direct air capture systems.

In any aspects or embodiments described herein, the structured adsorptive monolith comprises an activated adsorbent. In any aspects or embodiments described herein, the structured adsorbent monolith includes a ceramic matrix. In any aspects or embodiments described herein, the structured adsorptive monolith is extruded or coated with an activated adsorbent material, such as, e.g., an activated carbon powder or granules, and/or a CO₂ sequestering agent. In certain embodiments, the ceramic matrix comprises at least one of a zeolite, clay, porous polymer, porous alumina, porous silica, molecular sieve, kaolin, titania, ceria, or a combination thereof.

In any aspects or embodiments described herein, the activated adsorbent is activated carbon, e.g., activated carbon powder or granules. In any aspects or embodiments described herein, the activated carbon material is derived from at least one of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, a synthetic polymer, natural polymer, lignocellulosic material, or a combination thereof. In any of the aspects or embodiments described herein, the structured adsorbent monolith comprises an adsorbent material derived from wood or wood dust.

The Brunauer-Emmet-Teller (B.E.T.) surface area method can characterize the specific surface area of a material. In any aspects or embodiments described herein, the activated carbon of the adsorbent described herein comprises a nitrogen B.E.T. surface area from about 600 to about 3000, from about 800 to about 2500, from about 1000 to about 2500, or from about 1300 to about 2500, from about 1400 to about 2500, from about 1300 to about 2000, from about 1400 to about 2000, or from about 1500 to about 2000 square meters per gram.

In certain embodiments, the activated carbon powder used to form the structured adsorbent monolith as described herein comprises a D₅₀ (median diameter) particle size of around 16-18 μm, and/or a D₉₀ of about 30 μm (i.e., 90% of the particles are about 30 μm or less).

Generally, the larger the surface area of the activated carbon, the greater its adsorption capacity. The available surface area of activated carbon is dependent on its pore volume. Since the surface area per unit volume decreases as individual pore size increases, large surface area generally is maximized by maximizing the number of pores of small dimensions and/or minimizing the number of pores of very large dimensions. Pore sizes are defined herein as micropores (pore width<about 2 nm), mesopores (pore width=2-50 nm), and macropores (pore width >50 nm, and nominally 50 nm-100 microns).

In any aspect or embodiment described herein, the activated carbon of the structured adsorptive monolith, e.g., activated carbon honeycomb, described herein has a micropore (pore size <2 nm) volume of less than (or equal to) 0.5 ml/g, less than (or equal to) 0.4 ml/g, less than (or equal to) 0.3 ml/g, less than (or equal to) 0.2 ml/g, or less than (or equal to) 0.1 ml/g. In any aspect or embodiment described herein, the activated carbon of the structured adsorptive monolith described herein has a micropore (pore size <2 nm) volume of from about 0.1 ml/g to about 0.5 ml/g, from about 0.2 ml/g to about 0.5 ml/g, from about 0.2 ml/g to about 0.4 ml/g or from about 0.2 ml/g to about 0.3 ml/g.

In any aspects or embodiments described herein, the activated carbon of the structured adsorptive monolith, e.g., activated carbon honeycomb, described herein has a mesopore (pore size >2 nm to about 50 nm) volume of greater than (or equal to) about 0.1 ml/g, greater than (or equal to) about 0.15 ml/g, greater than (or equal to) about 0.2 ml/g, greater than (or equal to) about 0.25 ml/g, greater than (or equal to) about 0.3 ml/g, greater than (or equal to) about 0.35 ml/g, greater than (or equal to) about 0.4 ml/g, greater than (or equal to) about 0.45 ml/g, greater than (or equal to) about 0.5 ml/g, greater than (or equal to) about 0.55 ml/g, or greater than (or equal to) about 0.6 ml/g. In any aspects or embodiments described herein, the activated carbon of the structured adsorptive monolith, e.g., activated carbon honeycomb, described herein has a mesopore (pore size >2 nm to about 50 nm) volume of from about 0.1 ml/g to about 0.6 ml/g, from about 0.15 ml/g to about 0.6 ml/g, from about 0.2 ml/g to about 0.6 ml/g, from about 0.25 ml/g to about 0.6 ml/g, from about 0.3 ml/g to about 0.6 ml/g from about 0.35 ml/g to about 0.6 ml/g, from about 0.4 ml/g to about 0.6 ml/g, or from about 0.45 ml/g to about 0.6 ml/g.

Pore volumes can be measured by nitrogen isotherm measured at 77 K and applying Micromeretics model in MicroActive software “N2@Carbon Slit Pores NLDFT” model with the regularization factor of 0.01. BET specific surface area (SSA) was measured by applying Brunauer-Emmett-Teller (BET) equation to the isotherm at relative pressures (P/P0) between 0.05 to 0.2. As such, in certain embodiments, the activated carbon of the structured adsorptive monolith, e.g., activated carbon honeycomb, described herein has a mesoporosity of at least about 40%, 42%, 44%, 46%, 48%, 50%, 52%, 54%, 56%, 58%, 60% or greater. In any aspect or embodiment described herein, the structured adsorbent monolith, e.g., activated carbon honeycomb, described herein comprises a macropore volume of from about 0.1 ml/g to about 0.4 ml/g, or from about 0.2 ml/g to about 0.35 ml/g.

In any aspects or embodiments described herein, the structured adsorbent monolith as described herein comprises from about 10 wt % to about 95 wt %, from about 20 wt % to about 80 wt %, or from about 20 wt % to about 70 wt % activated carbon.

In any of the aspects or embodiments of the structured adsorbent monolith, the cell density (i.e., channels or cells if viewed in cross-section per square inch (“cpsi”)) is, for example, from about 80 to about 1000 cpsi, from about 80 to about 900 cpsi, from about 80 to 800 cpsi, from about 80 to about 600 cpsi, from about 80 to about 500 cpsi, from about 80 to about 400 cpsi, from about 80 to about 300 cpsi, from about and including all subranges and combinations thereof.

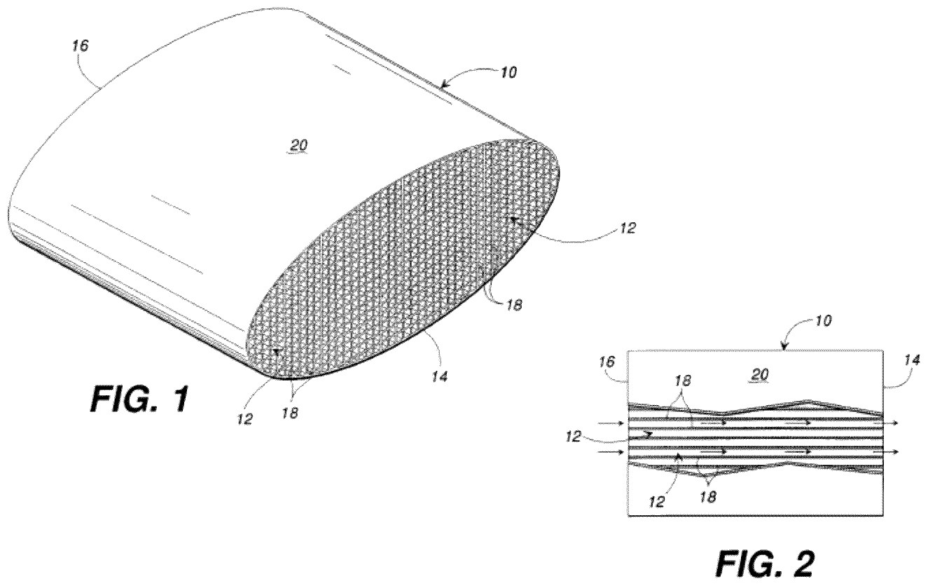

In any of the aspects or embodiments the structured adsorbent monolith as described herein has between about 100 and 6450 channels (or cells in cross-section), or between about 300-3200 channels (or cells in cross-section), inclusive of partial cells, e.g., cells in the periphery of the cross-section of a cylindrical part). As would be readily apparent to the skilled artisan, the cells of the structured adsorbent monolith, are representative of a cross-sectional view of the channels that extend along the interior length of the structured adsorbent monolith (see FIGS. 1 and 2). As such, the number and density of cells is equivalent to the number and density of channels. In any of the aspects or embodiments of the structured adsorbent monolith as described herein has a total channel area of between about 60 mm² and 2760 mm², or between about 125 mm² and 660 mm².

In any of the aspects or embodiments of the structured adsorbent monolith, the monolith is in the form of a geometric prism, e.g., oval, circular (i.e., cylinder), square, rectangular, triangular, pentagonal, hexagonal, etc., and as such, the parallel passages extend internally along the length of the prism parallel to each other and parallel to the outer surface. In any of the aspects or embodiments of the structured adsorbent monolith, the parallel passages can have any desired shape as viewed in cross-section, including square, rectangle, hexagon, octagon, triangle, circle, etc. In any of the aspects or embodiments of the structured adsorbent monolith, the monolith is in the form of a “honeycomb”. In any aspects or embodiments described herein, the honeycomb has an interior cell wall thickness of from about 0.1 mm to about 0.5 mm, an exterior cell wall thickness of from about 0.1 mm to about 0.5 mm, or a combination thereof.

In any aspects or embodiments described herein, the structured adsorptive monolith comprises at least one of an organic binder, inorganic binder a mineral flux or a combination thereof. In any aspects or embodiments described herein, the inorganic binder comprises a clay binder. In any aspects or embodiments described herein, the organic binder comprises a cellulose, e.g., methylcellulose, a cellulose derivative, or a combination thereof. In any aspects or embodiments described herein, the mineral flux comprises feldspathic material, netheline syenite or a combination thereof.

In any aspects or embodiments described herein, the clay binder comprises zeolite clay, bentonite clay, montmorillonite clay, illite clay, French green clay, pascalite clay, redmond clay, terramin clay, living clay, Fuller's Earth clay, ormalite clay, vitallite clay, rectorite clay, cordierite, ball clay, kaolin, hydrous kaolin, a calcined clay binder material (e.g., calcined kaolin), or a combination thereof. In any aspects or embodiments described herein, the calcined binder material comprises calcined kyanite, mullite, cordierite, clay grog, silica, alumina, and other calcined or non-plastic refractory ceramic materials, or a combination thereof. In any aspects or embodiments described herein, the ceramic matrix comprises sodium silicate.

In any of the aspects or embodiments described herein, the binder can comprise any suitable binder generally known in the art or that becomes known. In any of the embodiments described herein, the adsorbent composition or extruded adsorbent composition can comprise a polymeric binder selected from nylon, polyacrylic, fluoropolymer (PVDF). Those of skill in the art will recognize that certain types of binders are particularly useful for microporous or nanoporous, monolithic carbonaceous articles, which are expressly contemplated herein. For example, in certain embodiments, the binder is at least one of cellulosic binders and related esters, including, carboxymethyl cellulose, methylcellulose, ethyl cellulose, hydroxyethyl cellulose, ethyl methyl cellulose, methylcellulose ether, hydroxypropyl cellulose, ethyl hydroxyethyl cellulose, hydroxybutyl methylcellulose, hydroxypropyl methylcellulose, sodium alginate, hydroxyethyl methylcellulose, carboxymethylcellulose (CMC) and its derivatives and its metal salts (e.g. sodium carboxymethylcellulose), Teflon, novolac phenolic resin, humic acid-derived sodium salt, guar gum cellulose, starch, lignin, polyvinyl alcohol, polyacrylic acid, styrene butadiene resins (SBR), phenolic resin, polystyrene acrylic acid resins, reaction products of polyacrylic acid with polyols selected from the group of glycerin, polyvinyl alcohol, lignin and hydroxyethylcellulose, as well as derivatives and mixtures thereof, crystalline salts of aromatic sulfonates, polyfurfuryl alcohol, furfural, polyesters, polyepoxides, polyurethane polymers, polyvinyl alcohol or a combination thereof.

An alternative to aqueous binders is the use of certain non-solubilized, non-aqueous binders, such as clays, phenolic resins, polyacrylates, poly vinyl acetates, polyvinylidene chloride (PVDC), ultra-high molecular weight polyethylene (UHMWPE), etc. In certain embodiments, the non-aqueous binder of the present disclosure is at least one binder selected from the group consisting of a fluoropolymer (e.g. poly(vinylidene difluoride), (PVDF)), polytetrafluoroethylene (PTFE), fluorinated ethylene propylene, or perfluoroalkoxy alkanes), a polyamide (e.g., Nylon-6,6′ or Nylon-6), a polyamide, fibrillated cellulose, a high-performance plastic (e.g. polyphenylene sulfide), copolymer with a fluoropolymer, a copolymer with a polyamide, a copolymer with a polyimide, a copolymer with a high-performance plastic or a combination thereof.

Additional potential binders include thermosetting binders and hot-melt binders. Thermosetting binders are compositions based on thermosetting resins which are liquid or solid at ambient temperature and in particular those of urea-formaldehyde, melamine-urea-formaldehyde or phenol-formaldehyde type, resins of melamine-urea-formaldehyde type being preferred as well as emulsions of thermosetting (co)polymers in the latex foam. Crosslinking agents can be incorporated in the mixture. Mention may be made, as example of crosslinking agents, of ammonium chloride. Hot-melt binders are generally solid at ambient temperature and are based on resins of hot-melt type. Use may also be made, as binders, of pitch, tar or any other known binder. In any of the aspects or embodiments described herein, the cellulose ether is sublimated during calcination of the adsorbent

In any of the described aspects or embodiments, the adsorbent composition or extruded adsorbent composition as described herein is produced from polymeric binder crosslinking of a ground precursor activated carbon material, wherein the ground activated carbon material is in the form of a powder. For example, in certain embodiments, the extrudable composition as described herein is produced by taking a powdered activated carbon material and applying the crosslinking polymeric binder technology of U.S. Pat. No. 6,472,343.

In any of the aspects or embodiments described herein, the polymeric binder is included in an amount of about 1 wt %, about 2 wt %, about 3 wt %, about 4 wt %, about 5 wt %, about 6 wt %, about 7 wt %, about 8 wt %, about 9 wt %, or about 10 wt %, including all values and ranges in between, each based on the total weight of the adsorbent composition or extrudable adsorbent composition.

In any of the described aspects or embodiments, the amount of polymeric binder is less than about 10 wt %, for example from about 0.05 wt % to about 10 wt %, from about 0.1 wt % to about 10 wt %, from about 0.5 wt % to about 10 wt %, from about 1.0 wt % to about 10 wt %, from about 1.5 wt % to about 10 wt %, from about 2.0 wt % to about 10 wt %, from about 2.5 wt % to about 10 wt %, from about 3.0 wt % to about 10 wt %, from about 3.5 wt % to about 10 wt %, or from about 4.0 wt % to about 10 wt % including all values in between, each based on the total weight of the extrudable adsorbent composition. In any of the described aspects or embodiments, the polymeric binder is methylcellulose, hydroxypropyl methylcellulose, methyl hydroxyethyl cellulose and is present in an amount of less than about 10 wt %, for example from about 0.05 wt % to about 10 wt %, from about 0.1 wt % to about 10 wt %, from about 0.5 wt % to about 10 wt %, from about 1.0 wt % to about 10 wt %, from about 1.5 wt % to about 10 wt %, from about 2.0 wt % to about 10 wt %, from about 2.5 wt % to about 10 wt %, from about 3.0 wt % to about 10 wt %, from about 3.5 wt % to about 10 wt %, or from about 4.0 wt % to about 10 wt %, including all values in between, each based on the total weight of the adsorbent composition or extrudable adsorbent composition

Conventional compositions include a substantial portion of moldable, inorganic binder material which is plastic in nature and thus, when mixed with liquid, can be molded or extruded into a shape and will maintain that shape through drying and firing. An example of a moldable, inorganic binder material used in conventional compositions is ball clay, such as commercially available OLD MINE #4 ball clay (available from Kentucky-Tennessee Clay Company of Mayfield, KY). However, undesirably, high loading of materials such as ball clay required in conventional compositions can cause increased wear on the extrusion dies, which can increase the production costs.

In any of the aspects or embodiments described herein, the adsorbent composition includes from about 0 to about 50 wt % of a clay binder. In any of the aspects or embodiments described herein, the clay binder is relatively low in crystalline silica (e.g., less than about 5%). In any of the aspects or embodiments described herein, the amount of clay is minimized in order to reduce wear and prolong useful life of production equipment, e.g., extrusion dies.

In any of the aspects or embodiments described herein, the adsorbent composition or extruded adsorbent composition includes from about 0 to about 45 wt % of a calcined binder material, including for example, clay and/or silica sol. In any of the aspects or embodiments described herein, the calcined clay binder is a combination of fine and medium sized particles. In any of the aspects or embodiments described herein, the kaolin clay binder includes fine and medium sized calcined kaolin particles. For example, GLOMAX® kaolin (Imerys Kaolin, Inc., GA) is a medium particle size calcined kaolin. Calcined binder materials can include calcined kyanite, mullite, cordierite, clay grog, silica, alumina, and other calcined or non-plastic refractory ceramic materials and combinations thereof. In any of the aspects or embodiments described herein, the calcined binder material includes calcined kaolin clay, e.g, GLOMAX LL (Imerys Kaolin, Inc., GA).

In any of the aspects or embodiments described herein. The calcined binder material is present in the adsorbent composition or extrudable adsorbent composition in an amount of from about 0 to about 45 wt %, from about 5 to about 40 wt %, from about 5 to about 35 wt %, from about 5 to about 30 wt %, from about 5 to about 25 wt %, from about 2 to about 20 wt %, from about 2 to about 15 wt %, from about 2 to about 10 wt %, from about 2 to about 8 wt %, or from about 5 to about 10 wt %, each based on the total weight of the composition.

In any of the aspects or embodiments described herein, the adsorbent composition or extruded adsorbent composition includes from about 2 to about 20 wt % of a mineral flux. In certain embodiments, the mineral flux comprises a feldspar mineral. In certain embodiments, the mineral flux is nepheline syenite, a naturally occurring silica deficient sodium-potassium aluminosilicate, e.g., MINEX® (Covia Canada, Ltd., Ontario, CA). MINEX contains less than one tenth of one percent free crystalline silica.

In any of the aspects or embodiments described herein, the adsorbent composition or extrudable adsorbent composition includes from about 0 to about 5 wt % or an inorganic binder, such as for example, silica sol. In any of the described aspects or embodiments, the silica sol is sodium silicate which increases the strength of both the dry, but unfired extruded article and the fired extruded article, and acts as a flux material. In any of the described aspects or embodiments, the silica sol is present in an amount of from about 0 to about 5 wt %, from about 0 to about 4 wt %, from about 0 to about 3 wt %, from about 0 to about 2.5 wt %, from about 0 to about 2 wt %, from about 0 to about 1.5 wt %, or from about 0 to about 1.2 wt %, each based on the total weight of the adsorbent composition or extrudable adsorbent composition. A suitable commercially available silica sol is amorphous SiO₂ (e.g., Bindzil 2040 NH4 available from Akzo Nobel). In certain embodiments, the extrudable adsorbent composition excludes sodium silicate.

In any of the described aspects or embodiments, the adsorbent composition or extrudable adsorbent composition include glass microspheres. In certain embodiments, the glass microspheres are non-hollow or hollow glass microspheres (e.g., “glass bubbles)” which provide a further advantage in increasing the speed and ease of extrusion and providing a more cost-efficient process.

In any of the aspects or embodiments, the glass microspheres are glass bubbles. “Glass bubbles” also commonly known as “glass microbubbles”, “hollow glass microspheres”, or “hollow glass beads” can be useful for lowering weight and improving processing, dimensional stability, and flow properties of compositions. Generally, it is desirable that the glass bubbles be strong to avoid being crushed or broken during extrusion. Useful hollow glass particles include those marketed by 3M Co. (St. Paul, Minn.) under the trade designation “3M GLASS BUBBLES” (e.g., grades—S32, K37, S38, S38HS, S38XHS, K46, D32/4500, H50/10000, S60, S60HS, and iM30K); glass bubbles marketed by Potters Industries, Valley Forge, Pa., (an affiliate of PQ Corporation) under the trade designations “Q-CEL HOLLOW SPHERES” and “SPHERICAL HOLLOW GLASS SPHERES” and hollow glass particles marketed by Silbrico Corp., Hodgkins, Ill. under the trade designation “SIL-CELL”. Exemplary glass bubbles include soda-lime-borosilicate glass bubbles (hollow spheres) with medium particle diameter (18 um), density 0.6 g/cc; crush strength (90% survival) of 27 k psi.

Glass microspheres can be useful for lowering weight and improving processing, dimensional stability, and flow properties of compositions. In certain embodiments, the glass microspheres are used as a filler and/or diluent, so as to minimize or eliminate the need for abrasive binders, e.g., ball clay. In certain embodiments, the glass microspheres reduce working capacity.

In any of the described aspects or embodiments, a honeycomb die is used in the extruding step to produce an extruded adsorbent, material having a honeycomb structure.

In any of the aspects or embodiments described herein, the binder of the adsorbent composition or the extruded adsorbent composition produced as described herein comprises at least one of a clay binder, a calcined binder, mineral flux, water or a combination thereof. In any of the aspects or embodiments described herein, the adsorbent composition or the extruded adsorbent composition produced as described herein comprises from about 0 to about 50 wt % of a clay binder, from about 0 to about 45 wt % of a calcined binder, from about 2 to about 20 wt % of a mineral flux or a combination thereof.

In any of the described aspects or embodiments, the description provides an extruded adsorbent composition produced according to the steps comprising: (a) admixing (i) from about 10 to about 95 wt % (including ranges in between or 20, 25, 30, 35, 40, 45, 50, 55, 60, 65, 70, 75, 80, 85, 90, or 95 wt %) of an activated adsorbent material, e.g., an activated adsorbent material comprising an activated adsorbent powder; (ii) from about 2 to about 10 wt % of an organic binder; (iii) from about 0 to about 50 wt % of a clay binder; (iv) from about 0 to about 45 wt % of a calcined clay binder; (v) from about 2 to about 20% of a mineral flux; (vi) from about 0 to about 5 wt % of a silica sol; and (vii) from about 3 to about 40 wt % of glass microspheres to form an adsorbent composition; and (b) extruding the adsorbent composition to form an extruded adsorbent composition. In certain embodiments, a honeycomb die is used in the extruding step to produce an extruded adsorbent composition having a honeycomb structure. As would be understood by the skilled artisan, the dry ingredients of the extruded adsorbent composition will be wetted to form a paste prior to extrusion and drying. As such, in any aspect or embodiment described herein, water is added to the components to form a wetted mass or paste prior to the extruding step.

In any of the aspects or embodiments described herein, the extruded composition comprises from about 10 to about 95 wt % of an activated adsorbent material, e.g., activated carbon, comprising an activated adsorbent powder; from about 2 to about 10 wt % of a polymeric organic binder; from about 0 to about 50 wt % of a clay binder; from about 0 to about 45 wt % of a calcined binder; from about 2 to about 20% of a mineral flux; from about 0 to about 5 wt % of a silica sol; and from about 3 to about 40 wt % of glass microspheres.

Different types of extruded adsorbent articles can be prepared from the adsorbent compositions or extrudable adsorbent compositions as described herein. These include (but are not limited to) granules, pellets (e.g., cylindrical pellets), spheres, sheets, ribbons, trilobes, and monoliths, including articles having parallel internal passageways extending therethrough, such as e.g., a honeycomb, for example a uniform or non-uniform honeycomb. In principle, any desired shape of extruded article can be formed with a proper shaping device. So, shapes such as monoliths, blocks, and other modular forms are envisioned as well, including particulate media of uniform shape, particulate media of non-uniform shape, structured media of extruded form, structured media of wound form, structured media of folded form, structured media of pleated form, structured media of corrugated form, structured media of poured form, structured media of bonded form, non-wovens, wovens, sheet, paper, foam, hollow-cylinder, star, twisted spiral, asterisk, configured ribbons, and combinations thereof. Formulations as described herein are particularly useful for the extrusion of honeycomb-type adsorbent articles.

In any aspects or embodiments described herein, the amine comprises a polyamine. In any aspects or embodiments described herein the polyamine comprises at least one of diamine (putrescine, cadaverine); triamine (spermidine), tetraamine (spermine), macrocyclic polyamines (1, 4, 7-triazacyclononane), tris(2-aminoethyl)amine, cyclean, 1,1,1-tris(aminomethyl)ethane, polyethylenimine (PEI), hexamethylenetetramine, ethyleneamines (ethylenediamine; EDTA, TMEDA), dimethylenetriamine, trimethylenetetramine, tetramethylenepentamine, pentamethylenehexamine, diethylenetriamine (DETA), triethylenetetramine (TETA), tetraethylenepentamine (TEPA), pentaethylenehexamine (PEHA), polyethylenepolyamine (PEPA), aminoethylethanolamine (AEEA), dipropylenetriamine, tripropylenetetramine, tetrapropylenepentamine, pentapropylenehexamine, dibutylenetriamine, tributylenetetramine, tetrabutylenepentamine, pentabutylenehexamine, aminoethylpiperazine, dipropylenetriamine, heavy polyamine X (HPA X), tallow amines, isomers thereof, salts thereof, complexes thereof, adducts thereof, or any mixture thereof. In some examples, the polyamine can be or include a mixture of linear, branched, and/or cyclic ethyleneamines and/or other alkyleneamines, polyethylene polyamines, pentaethylenehexamine mixtures, tetraethylenepentamine mixtures, triethylenetetramine mixtures, isomers thereof, salts thereof, or a combination thereof.

In any aspects or embodiments described herein, the polyamine comprises at least one of polyethylenimine (PEI), tetraethylenepentamine (TEPA), pentaethylenehexamine (PEHA), polyethylenepolyamine (PEPA), aminoethylethanolamine (AEEA), or a combination thereof.

As provided herein, mesoporous activated carbons are impregnated with amines and show high CO₂ capture capacity. The described adsorbents have comparable CO₂ capacity relative to conventional adsorbents made of mesoporous silica but have higher hydrothermal stability over cyclic adsorption/regeneration cycles.

Structured adsorbent monoliths, e.g., honeycomb monoliths with different sizes and cell densities, containing ceramic binders and highly porous activated carbons are amine-functionalized to develop adsorbents that can be effectively used for DAC systems. In certain embodiments, the carbon content in the adsorbents can vary from 10 to 80 wt %. Because of the presence of organized channels in the activated carbon monolith, they incur minimal pressure drop during capture process, which is important for saving energy. The high surface area and thin cell walls of the adsorbents as described herein significantly improves the adsorption kinetics, ensuring maximum utilization of adsorption capacity when large flow of air passing over it. In addition, activated carbon-based honeycombs can be processed at temperatures as high as 1000° C.; and therefore, they have high thermal stability.

In any of the aspects or embodiments described herein the honeycomb monolith structure is prepared by a method that includes extruding a blend comprising an adsorbent material and a binder to form a honeycomb shape monolith. In any of the aspects or embodiments of the honeycomb is prepared by a method that includes coating the channels of a honeycomb structure scaffold with a coating layer comprising an adsorbent material. In any of the aspects or embodiments of the monolith structure is prepared by a method that includes coating the channels of a parallel passage structure scaffold with a coating layer comprising a carbonaceous material that is converted in situ to an adsorbent by further thermal and/or chemical processing (e.g., pyrolizing or chemical activation). In any of the aspects or embodiments of the monolith structure is prepared by a method that includes forming the honeycomb shape by stacking or winding a corrugated sheet. In any of the aspects or embodiments described herein, the honeycomb shape is made from corrugated sheet that contains adsorbent.

Activated carbon has been processed to make it highly porous (i.e., having a large number of pores per unit volume), which imparts a high surface area. Activated carbons may be generated from a variety of materials, however most commercially available activated carbons are made from peat, coal, lignite, wood, and coconut shells. Based on the source, the carbon can have different pore sizes, ash content, surface order, and/or impurity profiles. Coconut shell-based carbon has predominantly a microporous pore size, whereas a wood-based chemically activated carbon contains significant pore volume within the mesoporous size range. In a preferred embodiment, the activated adsorbent material comprises an activated carbon powder.

Activated adsorbent material may be produced using a variety of processes including, but are not limited to, chemical activation, thermal activation, or combinations thereof. In any of the aspects or embodiments described herein, the activated adsorbent material precursor is wood. The activated adsorbent material precursor can be activated by heating the adsorbent material precursor and treating with added oxidizing agents, such as exogenously added activating (i.e. oxidizing) agents, such as carbon dioxide, oxygen, acids or superheated steam. An exemplary activated adsorbent material includes NUCHAR® (Ingevity Corporation, North Charleston, SC), which is derived from wood and activated with phosphoric acid.

In any of the aspects or embodiments described herein, the adsorbent composition is extruded. In any of the aspects or embodiments described herein, the adsorbent composition includes from about 10 to about 95 wt % of an activated adsorbent material, or from about 10 to about 90 wt %, from about 10 to about 85 wt %, from about 10 to about 80 wt %, from about 10 to about 75 wt %, from about 10 to about 70 wt %, or from about 10 to about 65 wt %, or from about 10 to about 60 wt %, or from about 10 to about 50 wt %, or from about 10 to about 45 wt %, from about 10 to about 40 wt %, from about 10 to about 35 wt %, from about 10 to about 30 wt %, or from about 10 to about 25 wt %, each based on the total weight of the adsorbent composition.

Currently available technologies (e.g., G10 mesoporous silica) have well-known issues in DAC applications, including adsorbent structural collapse and amine leaching under steam exposure during cyclic adsorption/regeneration of adsorbent. These issues are overcome by structured adsorbent monoliths, e.g., activated carbon adsorbent honeycomb monoliths, as described herein, which are desirably mesoporous, more robust, and show better thermal stability. Moreover, activated carbon makes is capable of efficient Joule heating, which is typical in DAC systems.

Additionally, the particular binder imparts additional mechanical and hydrothermal stability (stability towards steam) to the activated carbon honeycomb (ACH) making it a robust and reliable structured adsorbent.

In addition to industrial direct air capture systems, the structured adsorbent monoliths as described herein can also be employed in smaller-scale or modular CO₂ capture units like those used in submarine, aircraft cabins, spacecraft stations, underground and enclosed facilities etc. Other potential applications include combustion engine vehicles, purification of hydrogen generated during steam methane reforming process, biogas upgrade, post-combustion CO₂ capture (powerplants, cement, steel, and chemical manufacturing, etc.), pre-combustion CO₂ capture (Integrated Gasification Processes), and enhanced oil recovery (CO₂ injection and chemical feedstock).

In an additional aspect, the description provides a method of making a structured adsorbent monolith as described herein comprising, providing a mixture of an activated adsorbent material and a ceramic matrix material, extruding the material to form an structured adsorbent monolith and optionally calcining the extruded structured adsorbent monolith, and treating the structured adsorbent monolith with CO₂ sequestering agent, e.g., potassium carbonate or an amine, e.g., wherein when the CO₂ sequestering agent is an amine or a polyamine, forming an amine-functionalized structured adsorbent monolith. In any aspect or embodiment described herein, the structured adsorbent monolith is treated with an amine by dipping into a solution comprising an amine, e.g., a polyamine. In an additional aspect, the polyamine is included in the mixture with the activated adsorbent material, e.g., activated carbon powder, and a ceramic matrix material prior to extrusion. In still additional embodiments, the CO₂ sequestering agent, e.g., potassium carbonate or polyamine, is applied by spray coating onto the structured adsorbent monolith.

In an additional aspect, the disclosure provides method of making an amine functionalized structured activated adsorbent monolith as described herein. In one embodiment, the amine functionalized structured activated adsorbent monolith is extruded. For example, powder adsorbents are made through mixing methanol/ethanol with different amines to make amine solution and adding powder porous support (activated carbon, mesoporous silica, etc.) to make different ratio of amine to support (20-80 wt %). The mixture is left to mix overnight until all liquid gets vaporized. The residual mass is left in a vacuum oven at 50° C. for 3 h.

In another embodiment, a structured activated adsorbent support is functionalized with amines through dipping it in amine solutions with different concentrations. The dip coating process is conducted by dunking an activated adsorbent honeycomb monolith in amine solutions and taking it out as well as dunking and applying either vacuum or sonication for different time intervals. The residual mass is left in a vacuum oven at 50° C. for 3 h.

In certain additional embodiments, the adsorbent composition or extrudable adsorbent composition as described herein is formed into a structure comprising a matrix with approximately uniform cell or geometric structure, e.g., a honeycomb configuration, which permits or facilitates approximately uniform air or vapor flow distribution through the subsequent adsorbent volume. In further embodiments, the adsorbent material is formed into a structure that includes a combination of any of the foregoing.

The extruded adsorbent composition or article may include any one or more of the above features, which can be combined in any number of ways according to the present description and are expressly contemplated herein.

In any of the aspects or embodiments described herein, the extruded adsorbent article, e.g., adsorbent honeycomb structure, is dried in a manner so as to prevent cracking of the structure. To alleviate cracking, the extruded honeycomb structure is dried so that water is removed at substantially the same rate throughout the extruded honeycomb structure. Preferred drying methods include vacuum drying, freeze drying, microwave drying, radio frequency (RF) drying, and humidity control drying. More conventional drying methods can be used to dry the extruded honeycomb structure of the present invention but are less practical commercially. Such conventional methods include dielectric drying and warm air drying with the monolith wrapped in plastic.

Vacuum drying of the extruded honeycomb structure includes placing the extruded monolith in a vacuum chamber initially having ambient room temperature and atmospheric pressure within the vacuum chamber, reducing the pressure within the vacuum chamber at a rate and to a level sufficient to quickly freeze the water in the extruded honeycomb structure, and maintaining a reduced pressure within the vacuum chamber for a time sufficient for the frozen water in the extruded honeycomb structure to sublime until the extruded honeycomb structure is dried. This drying cycle may be interrupted temporarily to remove the extruded honeycomb structure to another chamber after the extruded honeycomb structure has been frozen. Freezing of the water in the extruded honeycomb structure immobilizes the water and stabilizes the size and shape of the extruded honeycomb structure. The initial vacuum desirably is a deep vacuum to quickly and uniformly freeze the extruded honeycomb structure. The vacuum freezes the extruded honeycomb structure more uniformly than if the extruded honeycomb structure were frozen in a cold chamber at atmospheric pressure. After freezing, the extruded honeycomb structure may then be moved to a second chamber which does not require quite as deep a vacuum as the first chamber. Sublimation can be completed in this second chamber. Desirably, during vacuum drying, the pressure within the vacuum chamber is reduced, within about 1 minute, from atmospheric pressure to a pressure less than about 1 torr, and desirably within the range from 30 micrometers to 1 torr. Alternatively, this second chamber can be at atmospheric pressure and sub-freezing temperature and the frozen extruded honeycomb structure can be dried with recirculating dehumidified air.

Freeze drying of the extruded honeycomb structure is carried out in the same manner as vacuum drying except that the structure is flash frozen before being placed into a vacuum chamber for drying by sublimation. The wet extruded honeycomb structure is frozen by placing the wet extruded honeycomb structure in a super cold chamber cooled by liquid nitrogen or other means known by those skilled in the art. Alternatively, the extruded honeycomb structure may be flooded with or dipped into super cold liquid such as liquid nitrogen to freeze the extruded honeycomb structure.

During the drying stage of freeze drying or vacuum drying wherein the extruded honeycomb structure is subjected to a vacuum, the temperature of the extruded honeycomb structure may be varied by application of energy by radiation, conduction, convection, or RF or microwave energy independently during drying to enhance water removal. Vacuum levels similar to those used for vacuum drying are used. The temperature of the extruded honeycomb structure should be maintained at or below a maximum of 32° F. to avoid non-uniform water loss and cracking.

Humidity control drying of the wet extruded honeycomb extruded honeycomb structure includes placing the extruded wet extruded honeycomb structure in a chamber initially having a relative humidity within the chamber of at least 92 percent and gradually reducing the relative humidity within the chamber until the extruded honeycomb structure is dried. Desirably, the initial relative humidity level in the chamber should be 98 percent or higher. The humidity in the chamber can be lowered in stages to effect substantially uniform moisture loss throughout the extruded honeycomb structure during each drying stage. The humidity conditioned air is circulated through the drying chamber and the passages of the honeycomb extruded honeycomb structure to ensure a uniform rate of moisture removal throughout the extruded honeycomb structure. The temperature within the chamber may be varied to enhance the drying action.

In any of the described aspects or embodiments, after a drying step, the dried extruded honeycomb structure is fired or calcined at a temperature from about 500° C. to about 1150° C., or from about 1000° C. to about 1150° C., in a nitrogen or other non-oxidizing or slightly reducing atmosphere. The extruded honeycomb structure should be fired at a temperature sufficient to react the ceramic forming materials together to create a matrix for holding the activated carbon and maintaining the honeycomb shape of the extrusion. The bonds created by the firing should be sufficient to create a matrix having a strength able to withstand handling and use of the extruded honeycomb structure in intended applications such as in an ozone filter for a xerographic device, a fuel adsorber in an automobile air intake system, or a catalyst support. When used as a catalyst support, the extruded honeycomb structure of the present invention can be coated with conventional catalyst coatings using conventional coating methods. The relatively high surface area of the material forming the extruded honeycomb structure of the present invention makes it desirable as a catalyst support.

In certain embodiments, the extruded material further has at least one of: (i) a ratio of pore volumes of 0.05-1 micrometer to 0.05-100 micrometers that is as described herein, e.g., greater than about 70%, (ii) a ratio of pore volumes of 0.05-0.5 micrometer to 0.05-100 micrometers that is as described herein, e.g., greater than about 20%, or (iii) a combination thereof. In certain embodiments, the shaping step is performed by extrusion.

In certain additional embodiments, the method includes step of drying, curing or calcining the extruded adsorbent composition or article. In certain embodiments the drying, curing or calcining step is performed for from about 30 minutes to about 20 hours. In certain embodiments, the drying curing or calcining step is performed for about 1, about 2, about 3, about 4, about 5, about 6, about 7, about 8, about 9, about 10, about 11, about 12, about 13, about 14, about 15, about 16, about 17, about 18, about 19, or about 20 hours, including all values in between. In certain embodiments, the drying, curing or calcining step is performed at a temperature ranging from about 100° C. to about 650° C. In certain embodiments, the drying, curing or calcining step is performed at a temperature of about 100° C., about 110° C., about 120° C., about 130° C., about 140° C., about 150° C., about 160° C., about 170° C., about 180° C., about 190° C., about 200° C., about 250° C., about 300° C., about 350° C., about 400° C., about 450° C., about 500° C., about 550° C., about 600° C., about 650° C., about 700° C., or about 750° C., or about 800° C., or about 850° C., or about 900° C., or about 950° C., or about 1000° C., or about 1050° C., or about 1100° C.

FIGS. 1 and 2 illustrates one embodiment of the functionalized structured adsorbent monolith 10 as described herein, e.g., an amine-functionalized activated carbon honeycomb. The monolith 10 shown in FIG. 1 an extruded monolith comprising activated carbon and ceramic material and having a honeycomb shape. The monolith has a plurality of passages 12 extending through the monolith from a frontal end 14 to a rearward end 16. The passages 12 are substantially square in cross section, linear along their length, and formed by surrounding walls 18 of the extruded material that is amine functionalized; however, the passages can have other cross-sectional shapes such as rectangular, round, triangular, hexagonal, oval, eliptical, and the like. The passages 12 are encased by an outer skin 20 of the extruded material. As described herein, the amine-functionalized structured adsorbent monolith 10 is useful as an adsorptive filter to adsorb VOCs and/or CO₂ gaseous or liquid phases, for example, when the amine-functionalized structured adsorbent monolith 10 is disposed in the flue gas exhaust.

In an additional aspect, the description provides a VOC or CO₂ capture system, e.g., a direct air capture (DAC) system, or capture system for a point-source comprising an air stream, e.g., fluid or vaporous stream (e.g., exhaust or a flue gas stream) conduit in communication with a chamber or housing comprising a structured adsorbent monolith as described herein (e.g., a contactor), which is in communication with a vent conduit that is open to the atmosphere. In certain embodiments, the contactor can be comprised within an industrial air stream treatment system or included in the exhaust system of a vehicle.

In certain embodiments, the system comprises a regeneration unit and/or a heating unit to facilitate desorption of adsorbed CO₂.

In an additional aspect, the description provides methods for reducing carbon dioxide emissions from an air stream point source or in a direct air capture (DAC) system, the method comprising contacting air or an air stream (e.g., an exhaust stream or flue gas) comprising a VOC or CO₂ with a system comprising a structured adsorbent monolith, e.g., a functionalized activated carbon honeycomb (ACH) as described herein, wherein the system effectuates at least partial removal of the VOCs or CO₂ from the air or air stream (e.g., an exhaust stream or flue gas). In certain embodiments, the method includes a step of regeneration of the structured adsorbent monolith by treating or exposing the adsorbent monolith with at least one of hot air, steam, electromagnetic radiation (e.g., microwave energy, or radio frequency), resistive heating or a combination thereof, thereby desorbing bound VOC or CO₂ from the structured adsorbent monolith.

In additional aspects, the adsorbent composition or extruded adsorbent composition as described herein is incorporated into a fluid separation system. In any aspect or embodiment, the fluid separation system includes any gas or liquid phase separation or purification application that utilizes a shaped adsorbent, such as, granule, pellet, monolith or honeycomb. For example, by way of non-limiting example, the adsorbent composition or extruded adsorbent composition as described herein is incorporated into a system to purify air or other gases, such as hydrocarbon (e.g., methane, natural gas, propane, butane, ethylene, solvents), and non-hydrocarbons (e.g., hydrogen, nitrogen, oxygen, carbon dioxide, noble gases), and water, non-aqueous process and non-process liquids.

### Examples

With reference to the accompanying figures.

In certain examples, NuChar® HD and RGC, two micro-/mesoporous activated carbons (Ingevity Corp., North Charleston, SC), were impregnated in an amine solution of 20 and 40 wt %, for example, polyethyleneimine (PEI) and tetraethylenepentamine (TEPA), and their CO₂ capture performance was measured using TGA by exposing them to 10 vol % CO₂ in N₂ at three temperatures (25° C., 50° C., and 75° C.). The performance was compared to a silica-based baseline support impregnated with the same ratio of amines. In the next step, activated carbon honeycomb (ACH) having 30 wt % activated carbon or 50 wt % activated carbon was functionalized with the same amines through dipping in amine solutions with different concentrations (5, 10, 15, 20, 25 wt %). The dip coating process was conducted by dunking ACH in the solutions and taking it out as well as dunking and applying either vacuum or sonication for different time intervals (1, 5, and 10 min). Similarly, the CO₂ capture performance of the developed adsorbents was measured using TGA by exposing them to 10 vol % CO₂ in N₂ at three temperatures (25° C., 50° C., and 75° C.).

CO₂ uptake of the select material at different CO₂ concentrations in dry and humid conditions as well as their adsorption kinetics will be measured using a dynamic sorption analyzer. The selectivity, recyclability, steam exposure resistance, pressure drop, and dynamic capacity of the materials will be assessed using a column breakthrough analyzer.

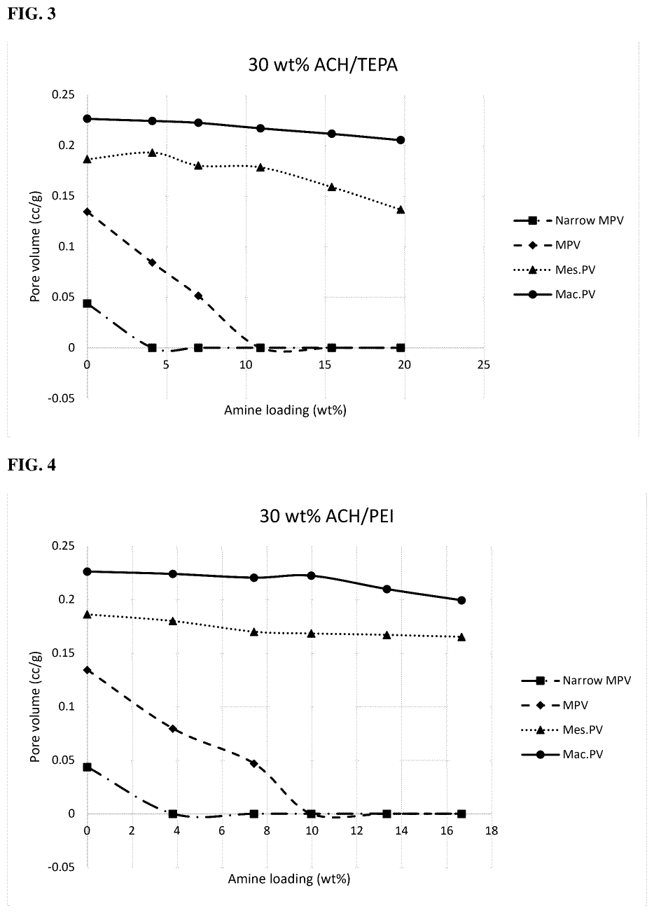

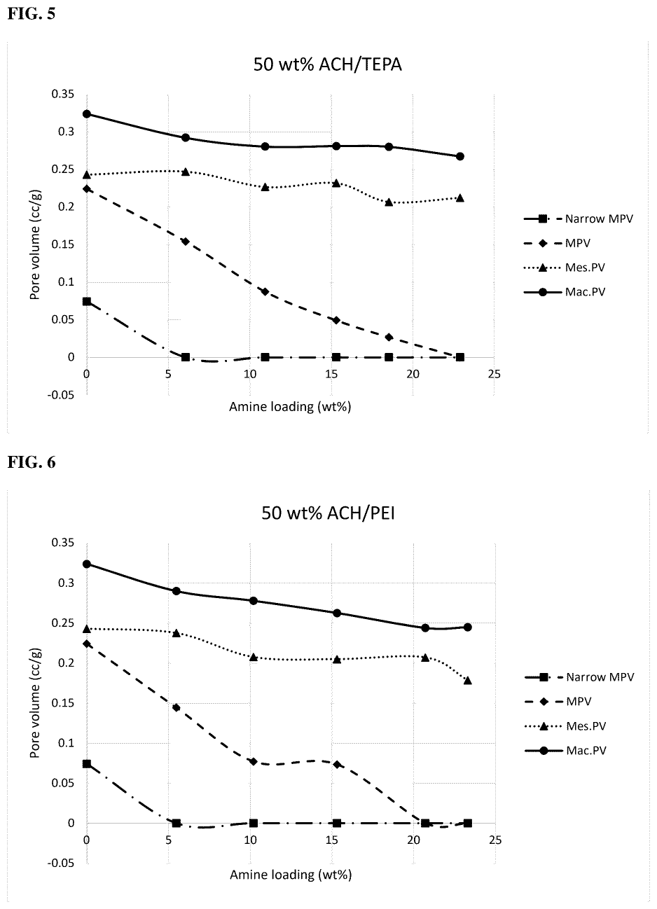

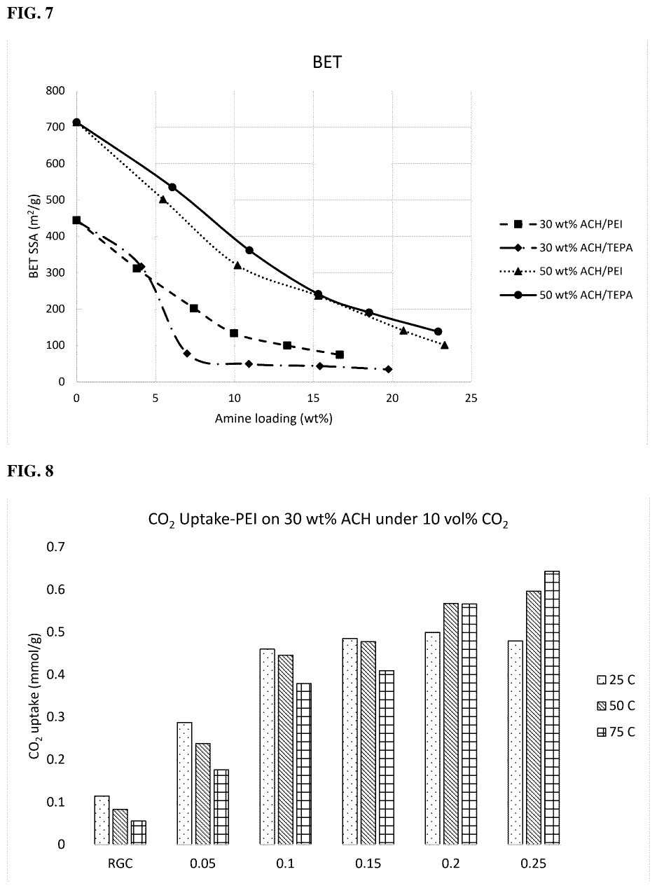

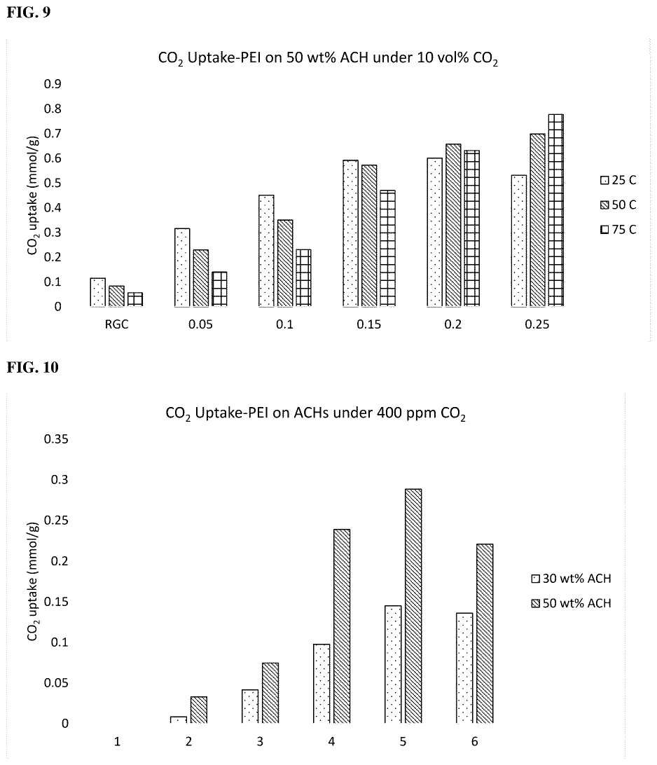

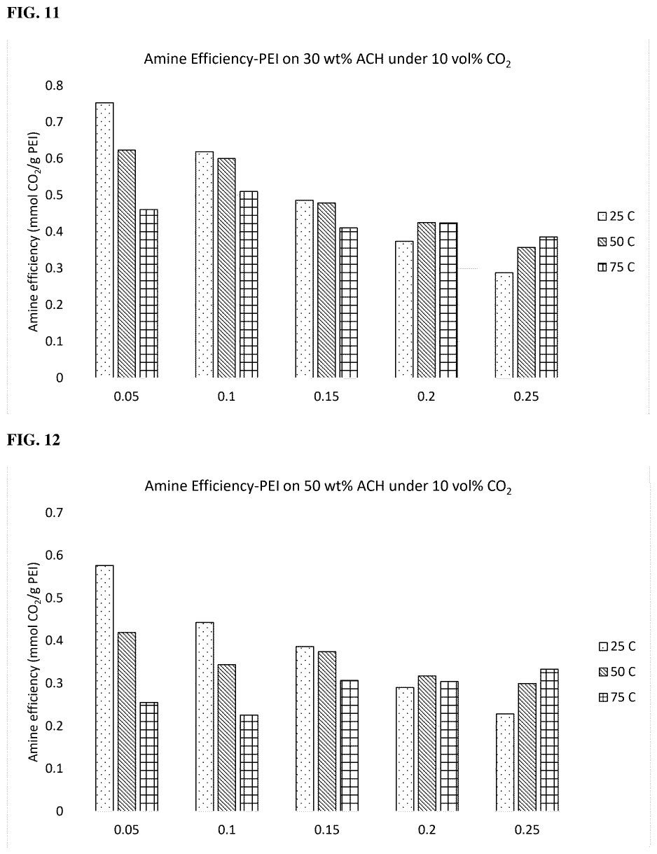

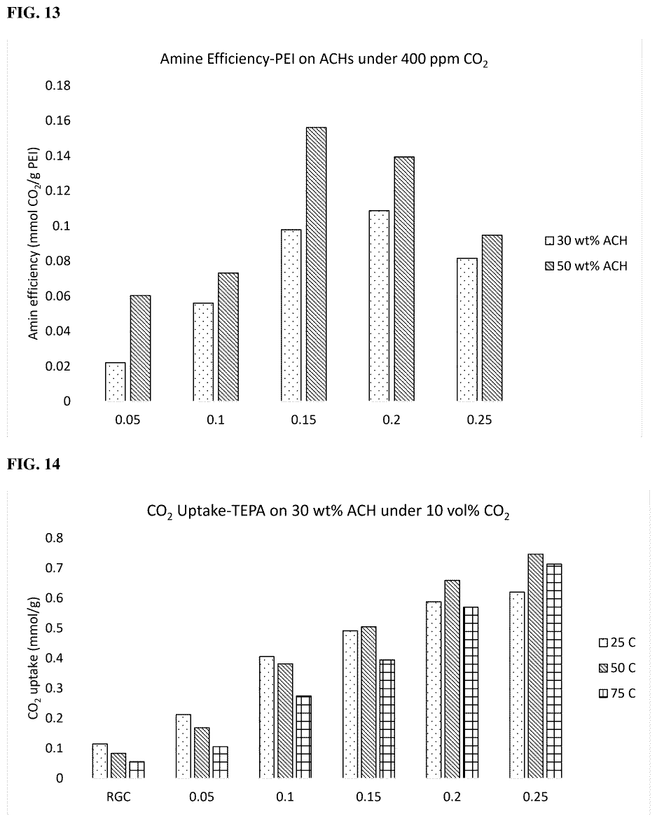

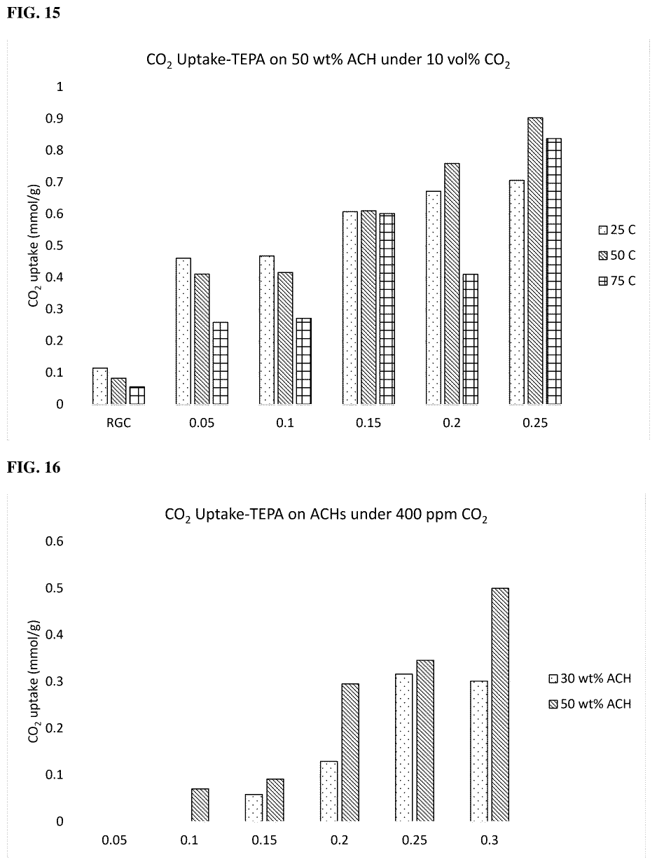

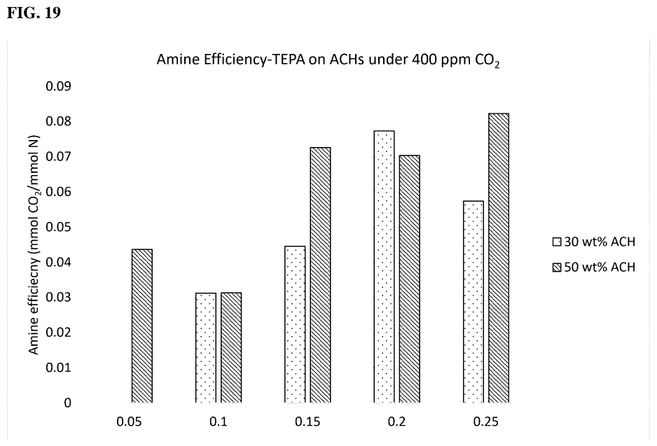

FIGS. 3-19 (and Tables 1-7) demonstrate examples of porosity, carbon uptake, and amine efficiency for exemplary functionalized active carbon honeycomb monoliths (ACH) compositions described herein. The indicated weight percentage refers to the weight fraction (wt %) of activated carbon in the wet mixture before extruding the activated carbon honeycomb article. Carbon content is based on the expected carbon content in the final part after calcination and is generally accurate to within a few tenths of a percent.

Tables 1 and 2 (and FIGS. 3-6) show that amine impregnation (PEI or TEPA) significantly reduces micropore volume, particularly at narrower pore sizes. Mesopore and macropore volume, however, are less impacted by amine impregnation. The effect of impregnation on porosity can be better observed by proportional decrease in BET surface area with increase of amine loading. For adsorbents made with PEI on activated carbon honeycombs (ACHs) comprising about 30 wt % activated carbon (“30 wt % ACH”) or about 50 wt % activated carbon (“50 wt % ACH”), 10% CO₂ capacity at 25° C. reaches a maximum when loaded with 20 wt % amine.

For ACHs loaded with 25 wt % PEI, increasing temperature led to increased CO₂ uptake, which is inconsistent with the reaction thermodynamics. The reason for this trend is pore overloading with amines, which imposes diffusional mass transfer limitations on CO₂ molecules. Therefore, to reach all amine sites CO₂ molecules can overcome diffusive mass transfer limitation at higher temperatures. For direct air capture (DAC), which typically takes place at low temperatures, we chose 20 wt % as optimal PEI solution concentration. The same argument also applies for the adsorbents made with TEPA. However, for TEPA the optimal loading for DAC is 25 wt %. These optimal solutions were used to make larger adsorbents that were tested on a breakthrough column to assess stability and measure dynamic capacity of the materials under different relative humidities (RHs).

TABLE 1
Porosimetry Summary (NDFT) for activated carbon honeycomb
(ACH) comprising 30 wt % carbon (30 wt % ACH) loaded
with either PEI or TEPA (pore volume in ml/g), and
BET surface area (See FIG. 3, 4).

| | Narrow | | | | |
|---|---|---|---|---|---|
| | Micropore | Micropore | Mesopore | Macropore | BET |
| 30 wt % ACH | Volume | volume | volume | Volume | S.A. |
| PEI loading | | | | | |
| (wt %) | | | | | |
| 0 | 0.044 | 0.13 | 0.19 | 0.23 | 443.8 |
| 3.81 | 0 | 0.08 | 0.18 | 0.22 | 311.5 |
| 7.43 | 0 | 0.05 | 0.17 | 0.22 | 202.2 |
| 9.97 | 0 | 0 | 0.17 | 0.22 | 133.4 |
| 13.34 | 0 | 0 | 0.17 | 0.21 | 99.6 |
| 16.67 | 0 | 0 | 0.17 | 0.20 | 74.2 |
| TEPA loading | | | | | |
| (wt %) | | | | | |
| 0 | 0.044 | 0.13 | 0.19 | 0.23 | 443.8 |
| 4.10 | 0 | 0.08 | 0.19 | 0.22 | 316.8 |
| 7.0 | 0 | 0.05 | 0.18 | 0.22 | 77.6 |
| 10.92 | 0 | 0 | 0.18 | 0.22 | 48.8 |
| 15.41 | 0 | 0 | 0.16 | 0.21 | 43.1 |
| 19.76 | 0 | 0 | 0.14 | 0.21 | 34.1 |

TABLE 2
Porosimetry Summary (NDFT) for activated carbon
honeycomb (ACH) comprising 50 wt % carbon (50 wt
% ACH) loaded with either PEI or TEPA (pore volume
in ml/g) and BET surface area (See FIG. 5, 6).

| | Narrow | | | | |
|---|---|---|---|---|---|
| | Micropore | Micropore | Mesopore | Macropore | BET |
| 50 wt % ACH | volume | volume | volume | Volume | S.A. |
| PEI loading | | | | | |
| (wt %) | | | | | |
| 0 | 0.074 | 0.22 | 0.24 | 0.32 | 713.6 |
| 5.48 | 0 | 0.14 | 0.24 | 0.29 | 501.5 |
| 10.20 | 0 | 0.08 | 0.21 | 0.28 | 320.3 |
| 15.31 | 0 | 0.07 | 0.21 | 0.26 | 236.3 |
| 20.72 | 0 | 0 | 0.21 | 0.24 | 140.6 |
| 23.32 | 0 | 0 | 0.18 | 0.25 | 101.3 |
| TEPA loading | | | | | |
| (wt %) | | | | | |
| 0 | 0.074 | 0.22 | 0.24 | 0.32 | 713.6 |
| 6.06 | 0 | 0.15 | 0.25 | 0.29 | 535.0 |
| 10.95 | 0 | 0.09 | 0.23 | 0.28 | 361.2 |
| 15.31 | 0 | 0.05 | 0.23 | 0.28 | 241.0 |
| 18.54 | 0 | 0.03 | 0.21 | 0.28 | 190.2 |
| 22.91 | 0 | 0 | 0.21 | 0.27 | 137.9 |

TABLE 3
PEI equilibrium capacity CO₂ uptake (mmol/g) of activated
carbon honeycomb (ACH) with 30 wt % or 50 wt % activated carbon
at 10 v % CO₂ at three different temperatures and under direct
air capture (“DAC”) conditions (See FIG. 8-10).

| | | | | | | DAC @ |
|---|---|---|---|---|---|---|
| | Amine | Amine | | | | 400 ppm |
| Part | solution | loading | 25° | 50° | 75° | CO₂ and |
| Description | (wt %) | (wt %) | C. | C. | C. | 30° C. |
| Activated | | | 0.11 | 0.08 | 0.06 | 0 |
| carbon | | | | | | |
| powder | | | | | | |
| 30 wt % ACH | 5 | 3.81 | 0.29 | 0.24 | 0.18 | 0.01 |
| 30 wt % ACH | 10 | 7.43 | 0.46 | 0.45 | 0.38 | 0.04 |
| 30 wt % ACH | 15 | 9.97 | 0.49 | 0.48 | 0.41 | 0.10 |
| 30 wt % ACH | 20 | 13.34 | 0.50 | 0.57 | 0.57 | 0.14 |
| 30 wt % ACH | 25 | 16.67 | 0.48 | 0.60 | 0.64 | 0.14 |
| 50 wt % ACH | 5 | 5.48 | 0.32 | 0.23 | 0.14 | 0.033 |
| 50 wt % ACH | 10 | 10.20 | 0.45 | 0.35 | 0.23 | 0.07 |
| 50 wt % ACH | 15 | 15.31 | 0.59 | 0.57 | 0.47 | 0.24 |
| 50 wt % ACH | 20 | 20.72 | 0.60 | 0.66 | 0.63 | 0.29 |
| 50 wt % ACH | 25 | 23.32 | 0.53 | 0.70 | 0.78 | 0.22 |

TABLE 4
Amine efficiency-PEI under 10 v % CO₂ (mmol CO₂/mmol amine) of activated carbon
honeycomb (ACH) comprising 30 wt % or 50 wt % carbon at different temperatures
and under direct air capture (“DAC”) conditions (See FIG. 11-13).

| | Amine | Amine | Amine | Amine | Amine | DAC Amine |
|---|---|---|---|---|---|---|
| | solution | loading | eff. | eff. | eff. | eff. @ 400 ppm |
| ACH | (wt %) | (wt %) | 25° C. | 50° C. | 75° C. | CO₂ and 30° C. |
| 30 wt % ACH | 5 | 3.81 | 0.75 | 0.62 | 0.46 | 0.02 |
| 30 wt % ACH | 10 | 7.43 | 0.62 | 0.60 | 0.51 | 0.06 |
| 30 wt % ACH | 15 | 9.97 | 0.49 | 0.48 | 0.41 | 0.10 |
| 30 wt % ACH | 20 | 13.34 | 0.37 | 0.43 | 0.42 | 0.11 |
| 30 wt % ACH | 25 | 16.67 | 0.29 | 0.36 | 0.39 | 0.08 |
| 50 wt % ACH | 5 | 5.48 | 0.58 | 0.42 | 0.26 | 0.06 |
| 50 wt % ACH | 10 | 10.20 | 0.44 | 0.34 | 0.23 | 0.07 |
| 50 wt % ACH | 15 | 15.31 | 0.39 | 0.37 | 0.31 | 0.16 |
| 50 wt % ACH | 20 | 20.72 | 0.29 | 0.32 | 0.30 | 0.14 |
| 50 wt % ACH | 25 | 23.32 | 0.23 | 0.30 | 0.33 | 0.10 |

TABLE 5
TEPA equilibrium capacity CO₂ uptake (mmol/g) of activated
carbon honeycomb (ACH) comprising 30 wt % or 50 wt % carbon at 10
v % CO₂ under three different temperatures and under direct
air capture (“DAC”) conditions (See FIG. 14-16).

| | | | | | | DAC @ |
|---|---|---|---|---|---|---|
| | Amine | Amine | | | | 400 ppm |
| Part | solution | loading | 25° | 50° | 75° | CO₂ and |
| Description | (wt %) | (wt %) | C. | C. | C. | 30° C. |
| activated | | | 0.11 | 0.08 | 0.06 | 0 |
| carbon | | | | | | |
| powder | | | | | | |
| 30 wt % ACH | 5 | 3.81 | 0.21 | 0.17 | 0.11 | 0 |
| 30 wt % ACH | 10 | 7.43 | 0.41 | 0.38 | 0.27 | 0.06 |
| 30 wt % ACH | 15 | 9.97 | 0.49 | 0.50 | 0.39 | 0.13 |
| 30 wt % ACH | 20 | 13.34 | 0.59 | 0.66 | 0.57 | 0.32 |
| 30 wt % ACH | 25 | 16.67 | 0.62 | 0.75 | 0.71 | 0.30 |
| 50 wt % ACH | 5 | 5.48 | 0.46 | 0.41 | 0.26 | 0.07 |
| 50 wt % ACH | 10 | 10.20 | 0.47 | 0.42 | 0.27 | 0.09 |
| 50 wt % ACH | 15 | 15.31 | 0.61 | 0.61 | 0.41 | 0.30 |
| 50 wt % ACH | 20 | 20.72 | 0.67 | 0.76 | 0.60 | 0.35 |
| 50 wt % ACH | 25 | 23.32 | 0.71 | 0.90 | 0.84 | 0.50 |
| 50 wt % ACH | 30 | 35.36 | | | | 0.49 |

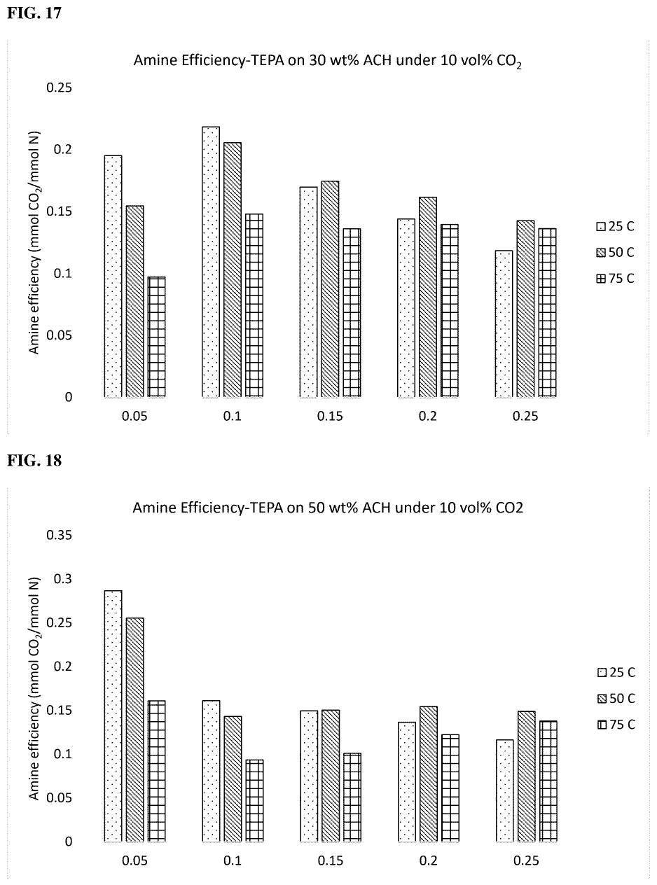

TABLE 6
Amine efficiency-TEPA of activated carbon honeycomb (ACH) comprising
30 wt % or 50 wt % carbon under 10 vol % CO₂ (mmol CO₂/mmol
amine) under three different temperatures and under direct
air capture (“DAC”) conditions (See FIG. 17-19).

| | Amine | Amine | Amine | Amine | Amine | DAC Amine |
|---|---|---|---|---|---|---|
| | solution | loading | eff. | eff. | eff. | eff. @ 400 ppm |
| ACH | (wt %) | (wt %) | 25° C. | 50° C. | 75° C. | CO₂ and 30° C. |
| 30 wt % ACH | 5 | 4.10 | 0.20 | 0.16 | 0.10 | 0 |
| 30 wt % ACH | 10 | 7.0 | 0.22 | 0.21 | 0.15 | 0.03 |
| 30 wt % ACH | 15 | 10.92 | 0.17 | 0.17 | 0.14 | 0.05 |
| 30 wt % ACH | 20 | 15.41 | 0.14 | 0.16 | 0.14 | 0.08 |
| 30 wt % ACH | 25 | 19.76 | 0.12 | 0.14 | 0.14 | 0.06 |
| 50 wt % ACH | 5 | 6.06 | 0.29 | 0.26 | 0.16 | 0.04 |
| 50 wt % ACH | 10 | 10.95 | 0.16 | 0.14 | 0.09 | 0.03 |
| 50 wt % ACH | 15 | 15.31 | 0.15 | 0.15 | 0.10 | 0.07 |
| 50 wt % ACH | 20 | 18.54 | 0.14 | 0.15 | 0.12 | 0.07 |
| 50 wt % ACH | 25 | 22.91 | 0.12 | 0.15 | 0.14 | 0.08 |

In any aspect or embodiment described herein, the amine functionalized structured adsorbent monolith, e.g., activated carbon honeycomb, comprises an amine loading of from about 2 wt % to about 25 wt %, from about 4 wt % to about 25 wt %, from about 6 wt % to about 25 wt %, from about 8 wt % to about 25 wt %, from about 10 wt % to about 25 wt %, from about 12 wt % to about 25 wt %, from about 14 wt % to about 25 wt %, from about 16 wt % to about 25 wt %, from about 18 wt % to about 25 wt %, from about 20 wt % to about 25 wt %. In any of the embodiments, the amie is PEI, TEPA, PEHA, PEPA, AEEA or a combination thereof.

In any aspect or embodiment described herein, the amine functionalized structured adsorbent monolith, e.g., activated carbon honeycomb, is configured to have at least one of (i) an equilibrium capacity CO₂ uptake of less than or equal to 3 mmol/g, from about 0.1 mmol/g to about 3.0 mmol/g, from about 0.2 mmol/g to about 3.0 mmol/g, from about 0.25 mmol/g to about 3.0 mmol/g, from about 0.3 mmol/g to about 3.0 mmol/g, from about 0.1 mmol/g to about 2.0 mmol/g, from about 0.15 mmol/g to about 2.0 mmol/g, from about 0.2 mmol/g to about 2.0 mmol/g, from about 0.2 mmol/g to about 1.5 mmol/g, or from about 0.2 mmol/g to about 1.0 mmol/g at 10 v % CO₂ at a temperature of from about 25° C. to about 75° C. (e.g., 25° C., 30° C., 35° C., 40° C., 45° C., 50° C., 55° C., 60° C., 65° C., 70° C. or 75° C.); (ii) an amine efficiency of from about 0.1 to about 0.8, from about 0.1 to about 0.7, from about 0.1 to about 0.6, or from about 0.1 to about 0.5 mmol CO₂/mmol amine at 10 v % CO₂ at a temperature of from about 25° C. to about 75° C. (e.g., 25° C., 30° C., 35° C., 40° C., 45° C., 50° C., 55° C., 60° C., 65° C., 70° C. or 75° C.), or (iii) a combination thereof. In any of the embodiments, the amie is PEI, TEPA, PEHA, PEPA, AEEA or a combination thereof.

In any aspect or embodiment described herein, the amine functionalized structured adsorbent monolith, e.g., activated carbon honeycomb, comprises a CO₂ uptake under direct air capture (DAC) conditions (i.e., 400 ppm CO₂ at 30° C.) of less than or equal to 2 mmol/g, from about 0.01 mmol/g to about 2 mmol/g, from about 0.05 mmol/g to about 2 mmol/g, from about 0.1 mmol/g to about 2 mmol/g, from about 0.15 mmol/g to about 2 mmol/g, from about 0.2 mmol/g to about 2 mmol/g, from about 0.2 mmol/g to about 1.5 mmol/g, or from about 0.2 mmol/g to about 1.0 mmol/g.

In any aspect or embodiment described herein, the amine functionalized structured adsorbent monolith, e.g., activated carbon honeycomb, is configured to have at least one of (i) an equilibrium capacity CO₂ uptake of from about 0.01 mmol/g to about 0.5 to about 3 (e.g., about 1, 1.5, 2, 2.5, or 3) mmol/g, (ii) an amine efficiency of from about 0.01 mm/g to about 0.2 mmol CO₂/mmol amine or (iii) both (i) and (ii). In certain embodiments, the activated carbon honeycomb has an equilibrium capacity CO₂ uptake of from 0.1 mmol/g to about 2 mmol/g 400 ppm CO₂ at a temperature of about 30° C. In any of the embodiments, the amine is PEI, TEPA, PEHA, PEPA, AEEA or a combination thereof.

TABLE 7
CO₂ uptake (mmol/g) capacity for activated carbon powder
(AC; duplicate test: “Dup.”) and G10 silica under
amine loading with 40 wt % solution at three temperatures.

| | Uptake at | Uptake at | Uptake at |
|---|---|---|---|
| 40 wt % amine | 25° C. | 50° C. | 75° C. |
| on support | (mmol/g) | (mmol/g) | (mmol/g) |
| AC-PEI | 1.40 | 1.54 | 1.53 |
| AC-PEI-Dup. | 1.37 | 1.48 | 1.42 |
| AC-TEPA | 1.7 | 1.87 | 1.55 |
| AC-TEPA-Dup. | 1.64 | 1.9 | 1.63 |
| G10-PEI | 1.75 | 2.04 | 2.24 |
| G10-TEPA | 2.33 | 2.58 | 2.66 |

TABLE 8
Equilibrium capacity CO₂ uptake (mmol/g) of activated carbon
honeycomb (ACH) comprising 50 wt % carbon under direct air
capture (“DAC”) conditions for amines PEHA, PEPA, AEEA.

| | Amine | | DAC @ |
|---|---|---|---|
| Part | solution | Amine | 400 ppm CO₂ |
| Description | (wt %) | Type | and 30° C. |
| 50 wt % ACH | 20 | PEHA | 0.37 |
| 50 wt % ACH | 25 | PEHA | 0.35 |
| 50 wt % ACH | 20 | PEPA | 0.23 |
| 50 wt % ACH | 25 | PEPA | 0.29 |
| 50 wt % ACH | 25 | AEEA | 0.40 |

### Adsorbent Preparation:

Powder adsorbents were made by mixing activated carbon powder (e.g., RGC, Ingevity Corp., North Charleston, SC) and G10 (mesoporous silica which is the competitive support) with two standard amines (polyethyleneimine (PEI) and tetraethylenepentamine (TEPA)). Amine composition for each support/amine pair was 40 wt %. The required amine was dissolved in 20-ml methanol at room temperature with constant stirring for 30 min. Then, the required amount of dried powder was added to the mixture and the stirring continued for six hours to completely evaporate methanol. The resulting solid material was collected and placed in oven at 50 C for three hours to remove residual methanol.

For activated carbon honeycomb adsorbents (ACH): about 30 wt % activated carbon powder or about 50 wt % activated carbon powder were used. Adsorbents were made by dipping the activated carbon ACH into different standard amine solutions with different concentrations (5, 10, 15, 20, 25 wt %) for one minute. To get rid of the excess surface amine, the parts were thoroughly cleaned by nitrogen flow. Then, they were placed in vacuum oven at about 50° C. for three hours to remove residual methanol.

### Amine Loading:

To calculate amine loading on each material, the dipped ACHs were put in vacuum oven at about 70° C. for approximately 24 hours. Amine loading was calculated by the weight difference between dried loaded ACH and blank ACH before dipping into the solution.

### Equilibrium CO₂ Capacity:

Equilibrium CO₂ capacity was measured using thermogravimetric analysis (TGA) at two conditions: (i) Condition 1 represents material performance for flue gas (10 to 15 vol % CO₂), in that the material was exposed to about 10 vol % CO₂ balance in N₂ at three different temperatures of about 25° C., 50° C., and 75° C., each temperature for approximately 1 hour; (ii) Condition 2 represents material performance for separation of CO₂ from air or direct air capture (DAC), in that the material was exposed to about 400 ppm balance in N₂ at about 30° C. for approximately 3 hours.

### Amine Efficiency:

For PEI-based adsorbents, amine efficiency was calculated by dividing the equilibrium CO₂ uptake (in mmol/g adsorbent) by PEI loading (g PEI/g adsorbent) by weight. It is expressed as mmol CO₂/weight of PEI.

For TEPA-based adsorbents amine efficiency was calculated by dividing the equilibrium CO₂ uptake by TEPA loading weight divided by molecular weight (MW) or TEPA multiplied by 5, which is the number of nitrogen atoms per molecule; the units are mmol CO₂/mmol N.

To calculate amine loading on each material, the dipped ACHs were put in vacuum oven at 70° C. for 24 hours. Amine loading was calculated by the weight difference between dried loaded ACH and blank ACH before dipping into the solution.

### Porosimetry Tests:

Narrow micropore volume (pore volume for pore size less than 7 Å), micropore volume (pore volume for pore size less than 20 Å), and mesopore volume (pore volume for pore size between 20 to 500 Å) were determined by measuring N₂ isotherm measured at 77 K and applying Micromeritics model in MicroActive software “N₂ @Carbon Slit Pores NLDFT” model with the regularization factor of 0.01. BET specific surface area (SSA) was measured by applying BET equation to isotherm at relative pressures (P/P0, where P is actual pressure and P0 is saturation pressure) between 0.05 to 0.2. Macropore volume was measured by using mercury intrusion porosimetry and the pore volume difference between 100 and 0.04 micrometer.

### BET Surface Area:

Surface areas were measured by nitrogen physisorption using the Brunauer-Emmet-Teller (BET) method according to ISO 9277:2010 in a Micromeritics ASAP 2420 or 3Flex (Norcross, GA). The sample preparation procedure was to degas at 250° C. (for porous supports such as carbon) or 110° C. (for amine-based adsorbents) for at least two hours, typically to a stable <2 μm Hg vacuum with the sample isolated. The nitrogen adsorption isotherm was recorded at 77 K for a 0.1 g sample, targeting the following pressures: 0.04, 0.05, 0.085, 0.125, 0.15, 0.18, 0.2, 0.355, 0.5, 0.63, 0.77, 0.9, 0.95, 0.995, 0.95, 0.9, 0.8, 0.7, 0.6, 0.5, 0.45, 0.4, 0.35, 0.3, 0.25, 0.2, 0.15, 0.12, 0.1, 0.07, 0.05, 0.03, 0.01. Actual points were recorded within an absolute or relative pressure tolerance of 5 mmHg or 5%, respectively, whichever was more stringent. Time between successive pressure readings during equilibration was 10 seconds. The non-ideality factor was 0.0000620. The density conversion factor was 0.0015468. The thermal transpiration hard-sphere diameter was 3.860 Å. The molecular cross-sectional area was 0.162 nm². The data in the range of 0.05 to 0.20 relative pressure of the nitrogen adsorption isotherm was used to apply the BET model.

### Determination of Pore Volumes:

Volume of pores (PV)<1.8 nm to 100 nm in size was measured by nitrogen adsorption porosimetry by the nitrogen gas adsorption method ISO 15901-2:2006 using a Micromeritics ASAP 2420 (Norcross, GA). The sample preparation procedure for nitrogen adsorption testing was to degas at 250 C for at least two hours, typically to a stable <2 μm Hg vacuum with the sample isolated. The determination of pore volumes for pores <1.8 nm to 100 nm in size was from the desorption branch of the 77 K isotherm for a 0.1 g sample. The nitrogen adsorption isotherm data was analyzed by the Kelvin and Halsey equations to determine the distribution of pore volume

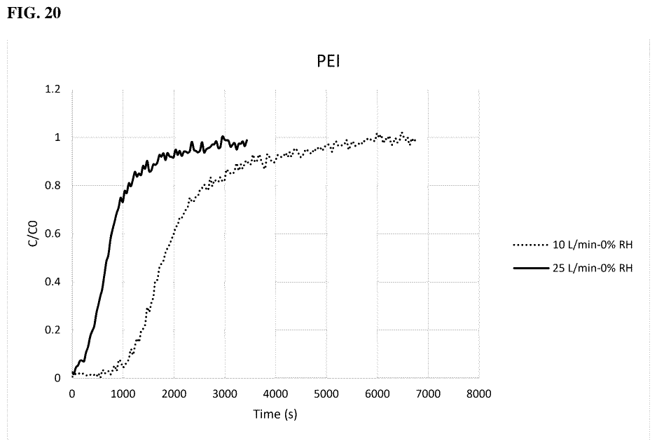

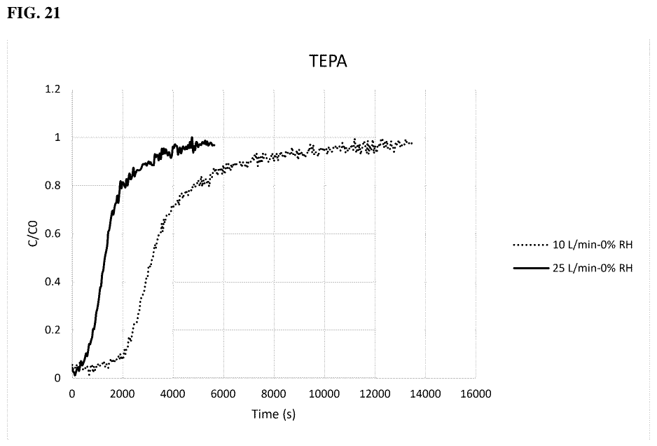

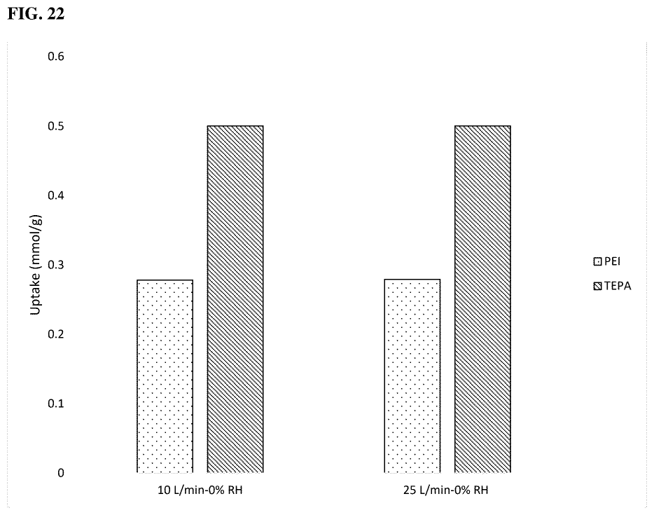

For the parts tested, impregnated with PEI or TEPA, increasing flow rates from 10 to 25 L/min decrease breakthrough time, but did not impact the saturation uptake (FIGS. 20, 21, 22).

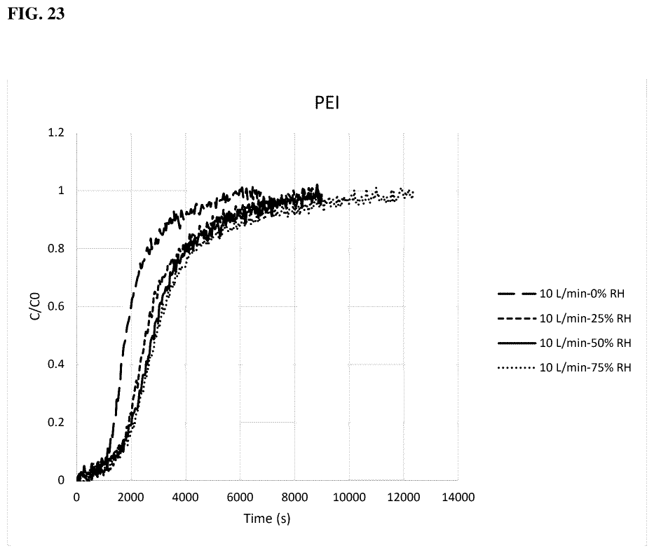

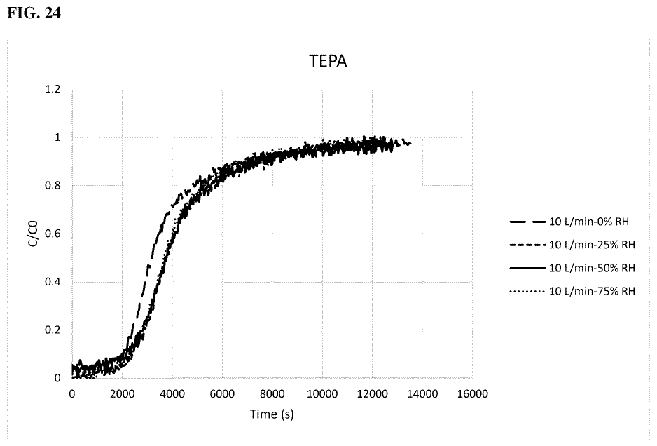

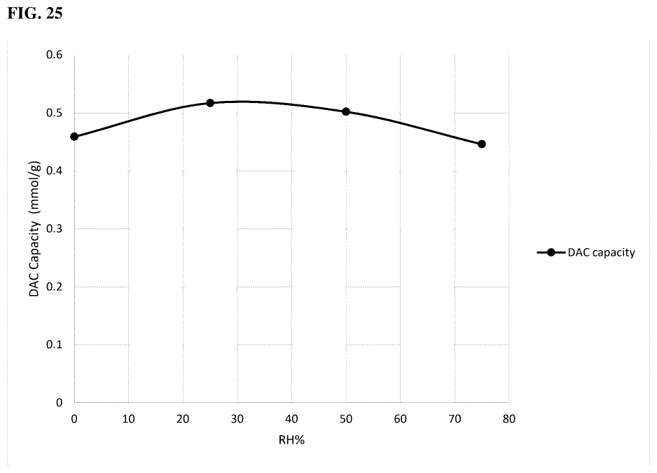

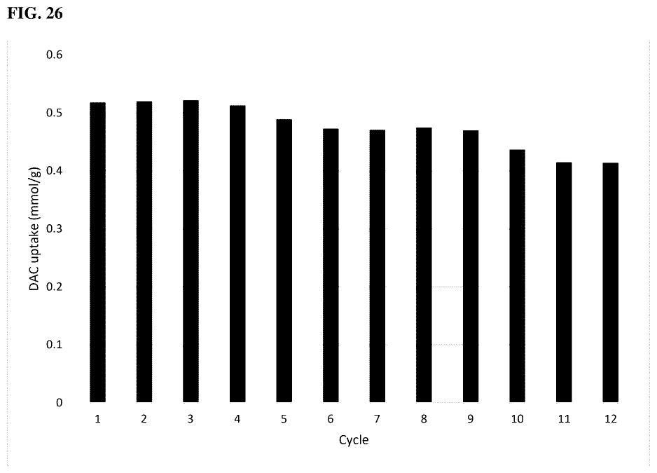

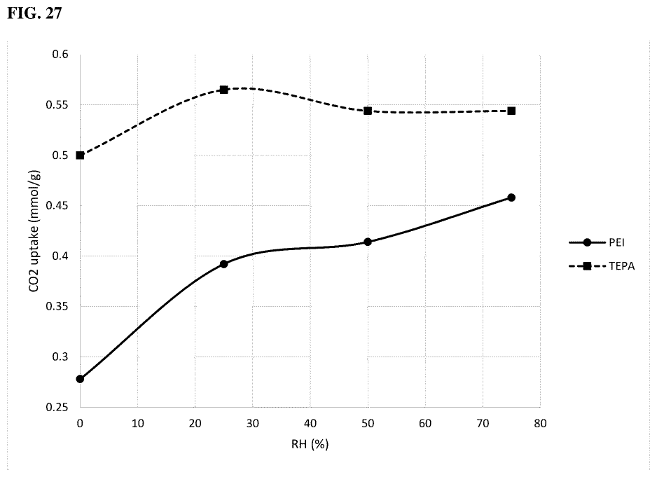

In dry conditions, CO₂ is adsorbed on amine groups through carbamate formation. Different levels of humidity were assessed to investigate the effect of humidity and flow rate on uptake. A CO₂ flow rate of 10 L/min with no humidity, and 25%, 50%, and 75% relative humidity (RH) was assessed for both PEI and TEPA treated parts having 50 wt % activated carbon (i.e., 50 wt % ACH). The adsorption test was performed at 30° C. for 4 hours. The cycles completed at 25% RH twelve times. FIGS. 23 and 27 show that the presence of humidity can improve DAC uptake due to further adsorption of CO₂ as bicarbonate, but most of the time at its elevated level could lead to decrease of CO₂ adsorption, likely due to competitive adsorption of water with CO₂.

The sample was heated at 110° C. for 1 hour under N₂ to regenerate during the cycles. After running 12 consecutive adsorption/regeneration, the DAC capacity was only slightly reduced (FIG. 26), showing that the described adsorbent materials are robust and stable.

Unlike many physical adsorbents such as zeolites or most of the MOFs the presence of humidity has positive impact on CO₂ adsorption performance of the adsorbents The increase in uptake is more noticeable for PEI-based adsorbents (FIG. 27).

### Breakthrough Test Method:

A monolith comprising 50 wt % activated carbon (i.e., activated carbon honeycomb monolith; or “ACH”) with 15 cm length and 2.4 cm diameter and 200 cpsi were impregnated by immersing the part into 20 wt % PEI solution and 25 wt % TEPA. The “wt % ACH” as used herein represents the weight fraction of activated carbon powder in the wet mixture before extruding the honeycomb article (ACH) and is based on the expected carbon content in the final part after calcination. The sample was put into vacuum oven at 50° C. for 3 h. The part was put into a column breakthrough system (mixSorb L series purchased from 3P Instruments). The sample was heated at 110° C. for 1 h to eliminate the residual methanol and moisture on sample.

### Thermogravimetric Analysis:

A honeycomb comprising 72 wt % uncalcined (i.e., “green”) activated carbon powder was extruded and compared to 50 wt % ACH (calcined and uncalcined)—all were treated with 20 wt % PEI solution. As shown in Table 9, The uncalcined 72 wt % ACH showed relatively higher DAC capacity than the 50 wt % ACH (calcined and uncalcined).

TABLE 9
Thermogravimetric analysis of CO2 uptake (mmol/g) for
activated carbon honeycomb having 50 wt % and 72 wt
% carbon (calcined or uncalcined) under direct air capture
(DAC) conditions of 400 ppm CO₂ and 30° C.

| Part | DAC (mmol/g) |
|---|---|
| 50 wt % ACH - Calcined | 0.25 |
| 50 wt % ACH - Uncalcined | 0.40 |
| 72 wt % ACH - Uncalcined | 0.45 |

Table 10 compares CO₂ uptake on adsorbent monoliths described herein under DAC conditions determined by gravimetric method (thermogravimetric analysis; “TGA”) and DAC by volumetric method (column breakthrough). The data indicate that DAC uptake measured by TGA comparable to that measured using the breakthrough (BT) method. Therefore, the uptake value measurement is accurate as both gravimetric and volumetric techniques show almost the same number, and amine impregnation is uniform across the sample and can be successfully scaled up from mg to g.

The lower DAC uptake from TGA with PEI samples could be because of lower flow rates in TGA and short adsorption time relative to BT. For TEPA the values are similar possibly because unlike PEI, TEPA has smaller molecules and incur less diffusional mass transfer limitation. Also, uncalcined part showed higher capacity. This is because of its higher pore volume allowing for more amine uptake relative to calcined parts.

TABLE 10
Gravimetric versus volumetric measurement of CO₂ uptake by activated
carbon honeycomb (ACH) having 50 wt % carbon during DAC for
calcined and uncalcined adsorbent honeycomb monoliths.

| | TGA | BT |
|---|---|---|
| | Capacity | Capacity |
| | (mmol/g) | (mmol/g) |
| Calcined 50 wt % ACH loaded in 20 wt % PEI | 0.21 | 0.28 |
| Uncalcined 50 wt % ACH loaded in 20 wt % PEI | 0.40 | 0.46 |
| Calcined 50 wt % ACH loaded in 25 wt % TEPA | 0.50 | 0.5 |

### The Impact of Water-Boiling on Precursor Porosity:

G10 (competitive silica material), activated carbon powder (“RGC”, Ingevity Corp., North Charleston, SC), and three activated carbon honeycomb monoliths (30 wt % and 50 wt % calcined ACH and 50 wt % uncalcined ACH) were boiled in water for different times and their BET surface area were measured (Table 11). This test indicates the stability of the precursors towards steaming.

TABLE 11
The impact of boiling on precursor BET area (m²/g).

| | | | | | 50 wt % |
|---|---|---|---|---|---|
| | | | 30 wt % | 50 wt % | ACH |
| Time | G10 | RGC | ACH | ACH | (uncalcined) |
| 1 min | 279.44 | 1594.35 | 436.80 | 818.68 | 759.29 |
| 5 min | 270.08 | 1635.52 | 443.27 | 793.21 | 740.74 |
| 15 min | 265.15 | 1530.55 | 451.93 | 754.95 | 474.20 |
| 30 min | 266.69 | 1522.32 | 455.54 | 753.16 | 762.41 |
| 60 min | 260.02 | 1546.33 | 473.96 | 759.92 | 762.29 |
| Reduction (%) | 6.95 | 3.01 | −8.51 | 7.18 | |

Boiling 30 wt % and 50 wt % calcined and uncalcined ACH resulted in different porosity change. For the 50 wt % calcined ACH there was a decrease in BET surface area, while for 30 wt % calcined ACH there was an increase in BET surface area. The reason for this different behavior is not clear but the changes are not significant and the integrity of the part remained intact. For the calcined part, boiling for 30 min reduced; however, the internal porosity did not change and it even increased with further boiling time.

After 60 minutes of boiling water, the BET value for G10 decreased to twice the reduction observed for RGC.

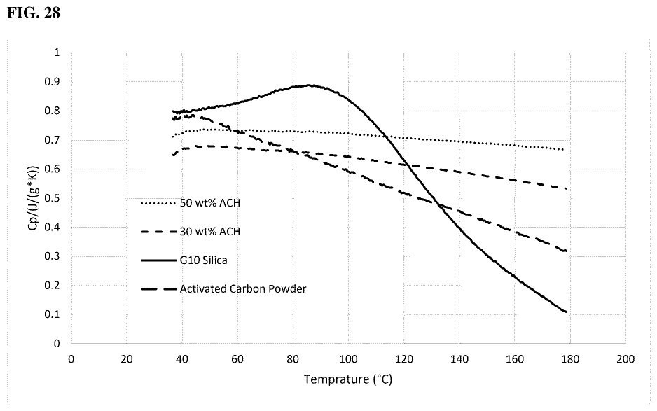

FIG. 28 demonstrates the specific heat capacity (Cp) comparison of adsorbent materials described and exemplified herein. Cp determined by differential scanning calorimetry using a NETZSCH STA 449 Jupiter F5 simultaneous thermal analyzer for activated carbon honeycomb (“ACH”) comprising 30 wt % and 50 wt % activated carbon, as compared to G10 silica and activate carbon powder. G10 silica exhibits the highest Cp values in the 70-110° C. range, which corresponds to the DAC regeneration temperature. This indicates that the ACH materials described herein incur a lower energy penalty during regeneration.

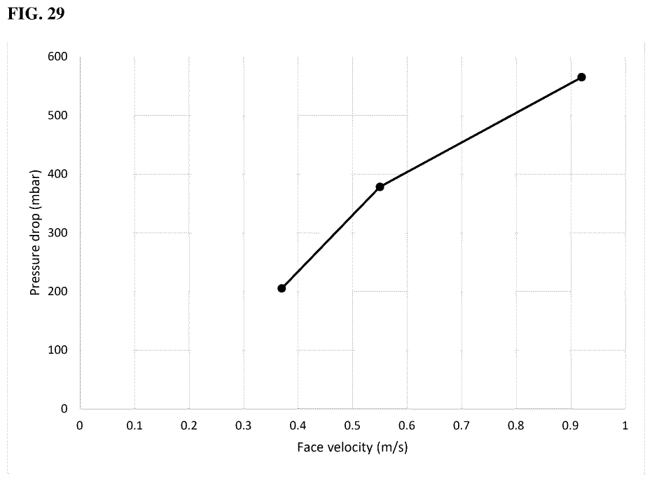

FIG. 29 shows the pressure drop across the structured adsorbent monolith as a function of air velocity. Adsorption tests on the impregnated parts were completed at different conditions: 10 and 25 L/min with no humidity to investigate the effect of flow rate on uptake, and 10 L/min with 25, 50, and 75% RH to investigate the impact of humidity. Adsorption test was completed at 30° C. for 4 h. Pressure drop increases approximately linearly with increasing face velocity (FIG. 29).

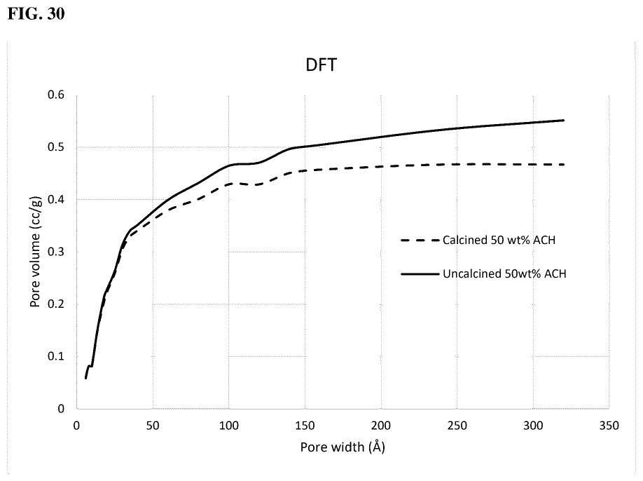

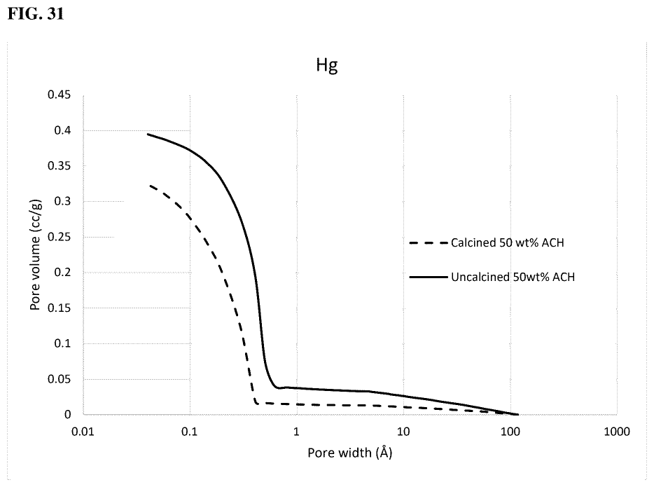

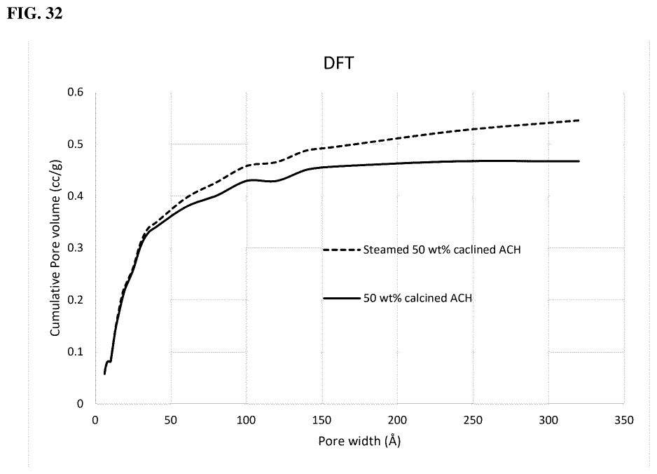

The density functional theory (DFT) and mercury porosimetry analysis (“Hg”) for calcined and uncalcined 50 wt % ACH was determined (FIGS. 30 and 31), macropore volume from uncalcined and calcined parts is included in the measurement. Uncalcined parts have more micro/meso/macro pore volume and BET surface area (749 m²/g versus 714 m²/g) than calcined parts.

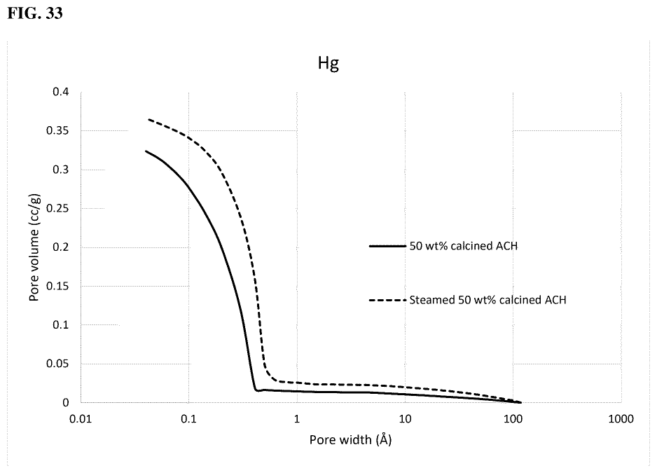

One common issue in DAC is the adverse impact of steam on porosity and structural integrity of adsorbent. Here, “green” (i.e., biochar) uncalcined 50 wt % ACH, and a calcined activated carbon honeycomb monolith were exposed to 100 g/h steam flow rate for 60 h under 0.2 bar on the 3P column breakthrough. Adsorption tests on the impregnated parts were completed at different conditions: 10 L/min with no humidity to investigate the effect of flow rate on uptake, and 10 L/min with 25, 50, and 75% RH to investigate the impact of humidity. Adsorption test was completed at 30° C. for 4 h. Long-term steaming did not disintegrate or collapse the monolith. It was found that long-term steaming even did not lead to pore collapse, but it did not change micropore volume and increased Meso-/macropore volume as evidenced by nitrogen and mercury porosimetry. Also, steaming did not have any impact on the structure of ACH and the structure of the monolith remained intact (no collapse) (See FIGS. 32 and 33).

Direct air capture (DAC) under conditions of 400 ppm CO₂ at 30° C. was performed on TGA for 72% uncalcined ACH and we exposed uncalcined 50 wt % ACH to steam for 60 h and found that the porosity did not change and the ACH retained its integrity.

Potassium Carbonate (K₂CO₃)

In an additional aspect, the disclosure provides a structured adsorbent monolith functionalized with potassium carbonate as the CO₂ sequestering agent. Potassium carbonate reacts with carbon dioxide and water to form potassium bicarbonate (KHCO₃). The reaction is reversible allowing K₂CO₃ to be generated by heating the bicarbonate, e.g., above 150° C. Table 12 provides CO₂ uptake data from a potassium carbonate functionalized activated carbon honeycomb monolith (two trials) having 30 wt % activated carbon and functionalized with 22 wt % K₂CO₃, at 10 v % CO₂ at three different temperatures, 25° C., 50° C., and 75° C.

TABLE 12
Potassium Carbonate functionalized activated carbon honeycomb
monoliths CO₂ uptake (mmol/g) at 10 v % CO₂.

| | CO₂ Uptake (mmol/g) | | |
|---|---|---|---|
| Part | 25° C. | 50° C. | 75° C. |
| 30 wt % ACH-1 | 0.34 | 0.37 | 0.29 |
| 30 wt % ACH-2 | 0.34 | 0.38 | 031 |

### Exemplary Embodiments

In an aspect, the disclosure provides a structured adsorptive monolith comprising a ceramic matrix material and an adsorbent material, wherein the monolith includes a plurality of hollow passages therethrough, and wherein the adsorbent is potassium carbonate or amine functionalized. In any aspect or embodiment described herein, the structured adsorptive monolith is extruded and includes an activated adsorptive material. In any aspect or embodiment described herein, the structured adsorptive monolith is coated with an activated adsorptive material. In any aspect or embodiment described herein, the activated adsorbent material is activated carbon. In any aspect or embodiment described herein, the ceramic matrix material comprises at least one of zeolite, clay, porous alumina, porous silica, molecular sieve, kaolin, titania, ceria, or a combination thereof. In any aspect or embodiment described herein, the extruded structured adsorptive monolith is a honeycomb. In any aspect or embodiment described herein, the honeycomb has a cell density of 100 to 1000 cells per square inch. In any aspect or embodiment described herein, the honeycomb has an interior cell wall thickness of 0.1 mm to 0.5 mm. In any aspect or embodiment described herein, the activated carbon material is derived from at least one of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, a synthetic polymer, natural polymer, lignocellulosic material, or a combination thereof. In any aspect or embodiment described herein, the amine comprises a polyamine. In any aspect or embodiment described herein, the polyamine comprises at least one of diamine (putrescine, cadaverine); triamine (spermidine), tetraamine (spermine), macrocyclic polyamines (1,4,7-triazacyclononane), tris(2-aminoethyl)amine, cyclean, 1,1,1-tris(aminomethyl)ethane, polyethylenimine (PEI), hexamethylenetetramine, ethyleneamines (ethylenediamine; EDTA, TMEDA), dimethylenetriamine, trimethylenetetramine, tetramethylenepentamine, pentamethylenehexamine, diethylenetriamine (DETA), triethylenetetramine (TETA), tetraethylenepentamine (TEPA), pentaethylenehexamine (PEHA), polyethylenepolyamine (PEPA), aminoethylethanolamine (AEEA), dipropylenetriamine, tripropylenetetramine, tetrapropylenepentamine, pentapropylenehexamine, dibutylenetriamine, tributylenetetramine, tetrabutylenepentamine, pentabutylenehexamine, aminoethylpiperazine, dipropylenetriamine, heavy polyamine X (HPA X), tallow amines, isomers thereof, salts thereof, complexes thereof, adducts thereof, or any mixture thereof. In some examples, the polyamine can be or include a mixture of linear, branched, and/or cyclic ethyleneamines and/or other alkyleneamines, polyethylene polyamines, pentaethylenehexamine mixtures, tetraethylenepentamine mixtures, triethylenetetramine mixtures, isomers thereof, salts thereof, or a combination thereof. In any aspect or embodiment described herein, the polyamine comprises at least one of polyethylenimine (PEI), tetraethylenepentamine (TEPA), pentaethylenehexamine (PEHA), polyethylenepolyamine (PEPA), aminoethylethanolamine (AEEA) or a combination thereof. In any aspect or embodiment described herein, the activated carbon comprises at least one of: a nitrogen B.E.T. surface area from about 1000 to about 2000 square meters per gram; a mesopore volume of >0.1 ml/g (e.g., 0.1 ml/g to 0.6 ml/g); a mesoporosity of at least about 40%; a macropore volume of 0.1 ml/g to about 0.4 ml/g; an amine loading of from about 3 wt % to about 25 wt %; an equilibrium capacity CO₂ uptake under 10 v % CO₂ at a temperature of from 25-75° C. of from about 0.1 mmol/g to about 1.0 mmol/g; an amine efficiency of from about 0.1 to about 0.8 mmol CO₂/mmol amine at 10 v % CO₂ at a temperature of from about 25° C. to about 75° C.; an equilibrium capacity CO₂ uptake of 0.01 to about 0.5 mmol/g, amine efficiency of from about 0.01 to about 0.2 mmol CO₂/mmol amine at 400 ppm CO₂ at 30 C; or a combination thereof. In any aspect or embodiment described herein, the structured adsorbent monolith comprises from about 10 wt % to about 90 wt % of activated carbon. In any aspect or embodiment described herein, the structured adsorbent monolith comprises at least one of an organic binder, a clay binder, a calcined clay binder, a mineral flux or a combination thereof. In any aspect or embodiment described herein, the organic binder comprises a cellulose, a cellulose derivative, or a combination thereof. In any aspect or embodiment described herein, the organic binder comprises at least one of carboxymethyl cellulose, methyl cellulose, ethyl cellulose, ethyl methyl cellulose, hydroxyethyl cellulose, hydroxypropyl cellulose, hydroxyethyl methyl cellulose, hydroxypropyl methyl cellulose, methyl hydroxyethyl cellulose, ethyl hydroxyethyl cellulose, crystalline salts of aromatic sulfonates, polyfurfuryl alcohols, polyesters, polyepoxides, polyurethane polymers, polyvinyl alcohol or a combination thereof. In any aspect or embodiment described herein, the clay binder comprises zeolite clay, bentonite clay, montmorillonite clay, illite clay, French ° clay, pascalite clay, redmond clay, terramin clay, living clay, Fuller's Earth clay, ormalite clay, vitallite clay, rectorite clay, cordierite, ball clay, kaolin, hydrous kaolin, or a combination thereof. In any aspect or embodiment described herein, the calcined binder material comprises calcined kyanite, mullite, cordierite, clay grog, silica, alumina, and other calcined or non-plastic refractory ceramic materials, or a combination thereof. In any aspect or embodiment described herein, the ceramic matrix material comprises sodium silicate. In any aspect or embodiment described herein, the ceramic matrix material comprises a flux material (e.g., feldspathic mineral, e.g., nepheline syenite).

In another aspect the disclosure provides a method of making a structured adsorbent monolith as described above comprising, providing a mixture of an activated adsorbent material and a ceramic matrix material, extruding the material to form an structured adsorbent monolith having a plurality of internal hollow passages, and functionalizing the structured adsorbent monolith with an amine to obtain an amine-functionalized structured adsorbent monolith. In any aspect or embodiment described herein, the structured adsorbent monolith is amine-functionalized by dipping into a solution comprising an amine. In any aspect or embodiment described herein, the amine is included in the mixture with the activated adsorbent material and ceramic matrix material prior to extrusion. In any aspect or embodiment described herein, the amine is applied by spray coating onto the structured adsorbent monolith. In any aspect or embodiment described herein, the amine is a polyamine. In any aspect or embodiment described herein, the polyamine comprises at least one of diamine (putrescine, cadaverine); triamine (spermidine), tetraamine (spermine), macrocyclic polyamines (1,4,7-triazacyclononane), tris(2-aminoethyl)amine, cyclean, 1,1,1-tris(aminomethyl)ethane, polyethylenimine (PEI), hexamethylenetetramine, ethyleneamines (ethylenediamine; EDTA, TMEDA), dimethylenetriamine, trimethylenetetramine, tetramethylenepentamine, pentamethylenehexamine, diethylenetriamine (DETA), triethylenetetramine (TETA), tetraethylenepentamine (TEPA), pentaethylenehexamine (PEHA), polyethylenepolyamine (PEPA), aminoethylethanolamine (AEEA), dipropylenetriamine, tripropylenetetramine, tetrapropylenepentamine, pentapropylenehexamine, dibutylenetriamine, tributylenetetramine, tetrabutylenepentamine, pentabutylenehexamine, aminoethylpiperazine, dipropylenetriamine, heavy polyamine X (HPA X), tallow amines, isomers thereof, salts thereof, complexes thereof, adducts thereof, or any mixture thereof. In some examples, the polyamine can be or include a mixture of linear, branched, and/or cyclic ethyleneamines and/or other alkyleneamines, polyethylene polyamines, pentaethylenehexamine mixtures, tetraethylenepentamine mixtures, triethylenetetramine mixtures, isomers thereof, salts thereof, or a combination thereof. In any aspect or embodiment described herein, the polyamine comprises at least one of polyethylenimine (PEI), tetraethylenepentamine (TEPA), pentaethylenehexamine (PEHA), polyethylenepolyamine (PEPA), aminoethylethanolamine (AEEA) or a combination thereof.

In another aspect, the disclosure provides an air capture (DAC) system comprising a fluid or vaporous stream conduit in fluid or vaporous communication with a chamber or housing comprising a structured adsorbent monolith as described above, wherein the structured adsorbent monolith is in fluid or vaporous communication with a vent conduit that is open to the atmosphere. In any aspect or embodiment described herein, the system further comprising a regeneration unit configured to desorb carbon dioxide from the structured adsorbent monolith

In another aspect, the disclosure provides a method for reducing carbon dioxide (CO₂) emissions from a fluid or vaporous stream in a direct air capture (DAC) system, the method comprising contacting the fluid or vaporous stream comprising CO₂ with the direct air capture system as described herein.

Those skilled in the art will recognize or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, any of the aspects or embodiments described herein can be combined collectively or in the alternative and that all such combinations are expressly contemplated and to not represent intermediate generalizations.

We claim:

1. A structured adsorptive monolith comprising a ceramic matrix material and an adsorbent material, wherein the monolith includes a plurality of hollow passages therethrough, and wherein the adsorbent is amine functionalized.

2. The monolith of claim 1, wherein the structured adsorptive monolith is extruded and includes an activated adsorptive material.

3. The monolith of claim 1, wherein the structured adsorptive monolith is coated with an activated adsorptive material.

4. The monolith of claim 2, wherein the activated adsorbent material is activated carbon.

5. The monolith of claim 1, wherein the ceramic matrix material comprises at least one of zeolite, clay, porous alumina, porous silica, molecular sieve, kaolin, titania, ceria, or a combination thereof.

6. The monolith of claim 2, wherein the extruded structured adsorptive monolith is a honeycomb.

7. The monolith of claim 6, wherein the honeycomb has a cell density of 100 to 1000 cells per square inch.

8. The monolith of claim 7, wherein the honeycomb has an interior cell wall thickness of 0.1 mm to 0.5 mm.

9. The monolith of claim 4, wherein the activated carbon material is derived from at least one of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, a synthetic polymer, natural polymer, lignocellulosic material, or a combination thereof.

10. The monolith of claim 1, wherein the amine comprises a polyamine.

11. The monolith of claim 10, wherein the polyamine comprises at least one of diamine (putrescine, cadaverine); triamine (spermidine), tetraamine (spermine), macrocyclic polyamines (1, 4, 7-triazacyclononane), tris(2-aminoethyl)amine, cyclean, 1,1,1-tris(aminomethyl)ethane, polyethylenimine (PEI), hexamethylenetetramine, ethyleneamines (ethylenediamine; EDTA, TMEDA), dimethylenetriamine, trimethylenetetramine, tetramethylenepentamine, pentamethylenehexamine, diethylenetriamine (DETA), triethylenetetramine (TETA), tetraethylenepentamine (TEPA), pentaethylenehexamine (PEHA), polyethylenepolyamine (PEPA), aminoethylethanolamine (AEEA), dipropylenetriamine, tripropylenetetramine, tetrapropylenepentamine, pentapropylenehexamine, dibutylenetriamine, tributylenetetramine, tetrabutylenepentamine, pentabutylenehexamine, aminoethylpiperazine, dipropylenetriamine, heavy polyamine X (HPA X), tallow amines, isomers thereof, salts thereof, complexes thereof, adducts thereof, or any mixture thereof. In some examples, the polyamine can be or include a mixture of linear, branched, and/or cyclic ethyleneamines and/or other alkyleneamines, polyethylene polyamines, pentaethylenehexamine mixtures, tetraethylenepentamine mixtures, triethylenetetramine mixtures, isomers thereof, salts thereof, or a combination thereof.

12. The monolith of claim 11, wherein the polyamine comprises at least one of polyethylenimine (PEI), tetraethylenepentamine (TEPA), pentaethylenehexamine (PEHA), polyethylenepolyamine (PEPA), aminoethylethanolamine (AEEA) or a combination thereof.

13. The monolith of claim 4, wherein the activated carbon comprises at least one of
(i) a nitrogen B.E.T. surface area from about 1000 to about 2000 square meters per gram;
(ii) a mesopore volume of >0.1 ml/g (e.g., 0.1 ml/g to 0.6 ml/g);
(iii) a mesoporosity of at least about 40%;
(iv) a macropore volume of 0.1 ml/g to about 0.4 ml/g;
(v) an amine loading of from about 3 wt % to about 25 wt %;
(vi) an equilibrium capacity CO₂ uptake under 10 v % CO₂ at a temperature of from 25-75° C. of from about 0.1 mmol/g to about 3.0 mmol/g;
(vii) an amine efficiency of from about 0.1 to about 0.8 mmol CO₂/mmol amine at 10 v % CO₂ at a temperature of from about 25° C. to about 75° C.;
(viii) an equilibrium capacity CO₂ uptake of 0.01 to about 1 mmol/g, amine efficiency of from about 0.01 to about 0.2 mmol CO₂/mmol amine at 400 ppm CO₂ at 30° C.; or
(ix) a combination thereof.

14. The monolith of claim 4, wherein the structured adsorbent monolith comprises from about 10 wt % to about 90 wt % of activated carbon.

15. The monolith of claim 1, wherein the structured adsorbent monolith comprises at least one of an organic binder, a clay binder, a calcined clay binder, a mineral flux or a combination thereof.

16. A method of making a structured adsorbent monolith comprising, providing a mixture of an activated adsorbent material and a ceramic matrix material, extruding the material to form a structured adsorbent monolith having a plurality of internal hollow passages, and functionalizing the structured adsorbent monolith with an amine to obtain an amine-functionalized structured adsorbent monolith.

17. The method of claim 16, wherein the structured adsorbent monolith is amine-functionalized by dipping into a solution comprising an amine.

18. The method of claim 16, wherein the amine is included in the mixture with the activated adsorbent material and ceramic matrix material prior to extrusion.

19. The method of claim 16, wherein the amine is applied by spray coating onto the structured adsorbent monolith.

20. The method of claim 16, wherein the amine is a polyamine.

21. The method of claim 20, wherein the polyamine comprises at least one of diamine (putrescine, cadaverine); triamine (spermidine), tetraamine (spermine), macrocyclic polyamines (1, 4, 7-triazacyclononane), tris(2-aminoethyl)amine, cyclean, 1,1,1-tris(aminomethyl)ethane, polyethylenimine (PEI), hexamethylenetetramine, ethyleneamines (ethylenediamine; EDTA, TMEDA), dimethylenetriamine, trimethylenetetramine, tetramethylenepentamine, pentamethylenehexamine, diethylenetriamine (DETA), triethylenetetramine (TETA), tetraethylenepentamine (TEPA), pentaethylenehexamine (PEHA), polyethylenepolyamine (PEPA), aminoethylethanolamine (AEEA), dipropylenetriamine, tripropylenetetramine, tetrapropylenepentamine, pentapropylenehexamine, dibutylenetriamine, tributylenetetramine, tetrabutylenepentamine, pentabutylenehexamine, aminoethylpiperazine, dipropylenetriamine, heavy polyamine X (HPA X), tallow amines, isomers thereof, salts thereof, complexes thereof, adducts thereof, or any mixture thereof. In some examples, the polyamine can be or include a mixture of linear, branched, and/or cyclic ethyleneamines and/or other alkyleneamines, polyethylene polyamines, pentaethylenehexamine mixtures, tetraethylenepentamine mixtures, triethylenetetramine mixtures, isomers thereof, salts thereof, or a combination thereof.

22. The method of claim 21, wherein the polyamine comprises at least one of polyethylenimine (PEI), tetraethylenepentamine (TEPA), pentaethylenehexamine (PEHA), polyethylenepolyamine (PEPA), aminoethylethanolamine (AEEA) or a combination thereof.

23. An air capture (DAC) system comprising a fluid or vaporous stream conduit in fluid or vaporous communication with a chamber or housing comprising a structured adsorbent monolith of claim 1, wherein the structured adsorbent monolith is in fluid or vaporous communication with a vent conduit that is open to the atmosphere.

24. The system of claim 23, further comprising a regeneration unit configured to desorb carbon dioxide from the structured adsorbent monolith.

25. A method for reducing carbon dioxide (CO₂) emissions from a fluid or vaporous stream in a direct air capture (DAC) system, the method comprising contacting the fluid or vaporous stream comprising CO₂ with the direct air capture system of claim 23.
